(19) United States
(12) Patent Application Publication
(10) Pub. No.: US 2006/0057568 A1
(43) Pub. Date: Mar. 16, 2006

(54) Method of identifying compounds that alter bag-1 mediated down-regulation of glucocorticoid-receptor transactivation

(76) Inventors: Ulrike Schmidt, Munchen (DE); Theo Rein, Munchen (DE); Florian Holsboer, Munchen (DE)

Correspondence Address: FISH & NEAVE IP GROUP;ROPES & GRAY LLP, ONE INTERNATIONAL PLACE, BOSTON, MA, 02110-2624, US

(21) Appl. No.: 10/495,472

(22) PCT Filed: Nov. 14, 2002
(86) PCT No.: PCT/EP02/12778

§ 371 Date: May 2, 2005

(30) Foreign Application Priority Data
Nov. 16, 2001 (EP) 011272598

(51) Int. Cl. C40B 40/08; C40B 40/10

(52) U.S. Cl. 435/6; 435/7.1; 514/2

(57) ABSTRACT

The present invention relates to new methods of identifying compounds that inhibit or reduce bag-1 mediated down-regulation of gluocorticoid-receptor (GR) tansactivation. These methods rely on the surprising findings, that first, a (poly)peptide comprising the motif X-Lys-Lys-Lys-Y-Arg-Arg-Arg also present is the cochaperone bag-1 is sufficient for DNA binding of this cochaperone and, second, this motif but not the E₂X₄ domain of bag-1 is required for inhibition or reduction of FR transactivation. The present invention also relates to methods of refining the compounds identified with the above method as well as to methods of producing pharmaceutical compositions wherein compounds identified or compounds refined by the above-recited methods of the invention are formulated with a pharmaceutically acceptable carrier or diluent.

The present invention relates to new methods of identifying compounds that inhibit or reduce bag-1 mediated downregulation of glucocorticoid-receptor (GR) transactivation. These methods rely on the surprising findings, that first, a (poly)peptide comprising the motif X-Lys-Lys-Lys-Y-Arg-Arg-Arg also present in the cochaperone bag-1 is sufficient for DNA binding of this cochaperone and, second, this motif but not the E₂X₄ domain of bag-1 is required for inhibition or reduction of GR-mediated transactivation. The present invention also relates to methods of refining the compounds identified with the above method as well as to methods of producing pharmaceutical compositions wherein compounds identified or compounds refined by the above-recited methods of the invention are formulated with a pharmaceutically acceptable carrier or diluent.

A number of documents including manufacturers' manuals is cited in this specification. The disclosure content of all these documents is herewith incorporated by reference.

BAG-1 (also denoted bag-1 throughout this application) was originally identified as an associating factor of the antiapoptotic factor bcl2 (Takayama et al., 1995) and, independently, as a protein called RAP46 that associates with the glucocorticoid receptor (GR) and other steroid hormone receptors (Zeiner and Gehring, 1995). It also is termed “hap46”, hsp70- and hsc70-associating protein (Gebauer et al., 1998). BAG-1 is involved not only in apoptosis and tumorigenesis (Thress et al., 2001; Turner et al., 2001), but also in the function of nuclear receptors. For example, BAG-1 enhances the transcriptional activity of the androgen receptor (Froesch et al., 1998; Knee et al., 2001), while in the case of the vitamin D receptor evidence has been provided for both enhancement (Guzey et al., 2000) and inhibition (Witcher et al., 2001) of transcriptional activity. In addition, BAG-1 interacts with the retinoic acid receptor (RAR) and inhibits its binding to retinoic acid response elements on DNA as well as RAR-dependent transcription (Liu et al., 1998). Likewise, BAG-1 has been described as a negative regulator of GR, since it binds to the hinge region of GR and inhibits DNA binding and transactivation of the receptor (Kullmann et al., 1998).

Before activation by hormone, GR resides in the cytoplasm, where it interacts with various molecular chaperones in a step-wise fashion to attain the competent hormone binding state (Bresnick et al., 1989; Pratt and Toft, 1997; Buchner, 1999). Central to this folding process are heat shock protein (hsp) 90, hsp70, and hsp70/hsp90 organizing protein (hop) (Dittmar et al., 1997; Pratt and Dittmar, 1998; Toft, 1998), which bridges hsp70 and hsp90 via its tetratricopeptide repeat (TPR) domains (Scheufler et al., 2000). Hsp90, hsp70 and hop, possibly with the involvement of hsp40 (Dittmar et al., 1998), form an intermediate complex with GR (Dittmar et al., 1996; Pratt and Toft, 1997), from which hsp70 and hop presumably dissociate to allow entry of p23 and one of the immunophilins to the final complex, where GR gains competence of binding to hormone.

The chaperone activity of hsp70 is modulated not only by BAG-1, but also by hsp40, C-terminus of hsp70 interacting protein (CHIP), and hsp70 interacting protein (hip). Hsp40 enhances the ATPase activity of hsp70 in vitro (Freeman et al., 1995) and the hsp70-dependent refolding in mammalian cells (Michels et al., 1999; Michels et al., 1997). Hip also has been identified as a positive regulator of hsp70 chaperone activity (Höhfeld et al., 1995; Nollen et al., 2000b). In contrast, CHIP has been found to inhibit the ATPase activity of hsp70 and to interfere with stable hsp70-substrate complexes (Ballinger et al., 1999). All isoforms of BAG-1, i.e. BAG-1L, BAG-1M, and BAG-1S, which derive from different translation initiation sites localized on the same gene (Packham et al., 1997; Takayama et al., 1998; Yang et al., 1998), have been described in several studies to inhibit hsp70-dependent refolding activity in vitro and in vivo (Bimston et al., 1998; Zeiner et al., 1997; Höhfeld and Jentsch, 1997; Nollen et al., 2000a; Nollen et al., 2000b). Moreover, BAG-1 was found to compete with the stimulatory action of hip (Nollen et al., 2000b). Hip, in turn, opposes the negative effect of BAG-1 on steroid binding of GR (Kanelakis et al., 2000). The negative effect of BAG-1 on steroid binding, however, was not observed by others (Schneikert et al., 1999).

While all these reports strongly suggest a cytosolic effect of BAG-1 on GR folding and activity, there are also data supporting a nuclear function of BAG-1. For example, BAG-1 has been reported to bind non-specifically to DNA and to stimulate DNA transcription (Zeiner et al., 1999). Deletion of or mutations within the N-terminal ten amino acids of BAG-1 abolish its DNA binding (Zeiner et al., 1999). In addition, it has been shown that BAG-1 is transported into the nucleus upon steroid binding and nuclear translocation of GR (Schneikert et al., 1999). This nuclear translocation is dependent on the C-terminal hsp70 binding domain of BAG-1. Moreover, the inhibiting effect of BAG-1 on DNA binding of GR (Kullmann et al., 1998) can be overcome in a cell free system by supplementing with increasing amounts of hsp70 (Schneikert et al., 2000).

While an hsp70 interaction domain of BAG-1 has been identified and characterised by crystallography in the C-terminal region (Briknarova et al., 2001; Sondermann et al., 2001), the function of the N-terminal part seems less clear. It has been suggested that a serine- and threonine-rich E₂X₄ domain is necessary for the inhibitory function of BAG-1 (Schneikert et al., 1999). If this indeed were the case, the control of bag-1 mediated inhibition of GR transactivation would be rather difficult to achieve due to the expected complex interplay of the various control elements involved. On the other hand, means and methods for the specific inhibition of bag-1 mediated downregulation of GR transactivation are clearly desired. For example, such means and methods would allow a reduction in the amount of glucocorticoid administered during glucocorticoid therapy. The main advantage of such an approach is the reduction of adverse side effects triggered by glucocorticoids.

Thus, the technical problem underlying the present invention was to provide such means and methods that will allow a specific inhibition of bag-1 mediated suppression of GR transactivation with a view to reduce the adverse side effects in glucocorticoid-related therapy.

The solution to said technical problem is achieved by providing the embodiments characterized in the claims.

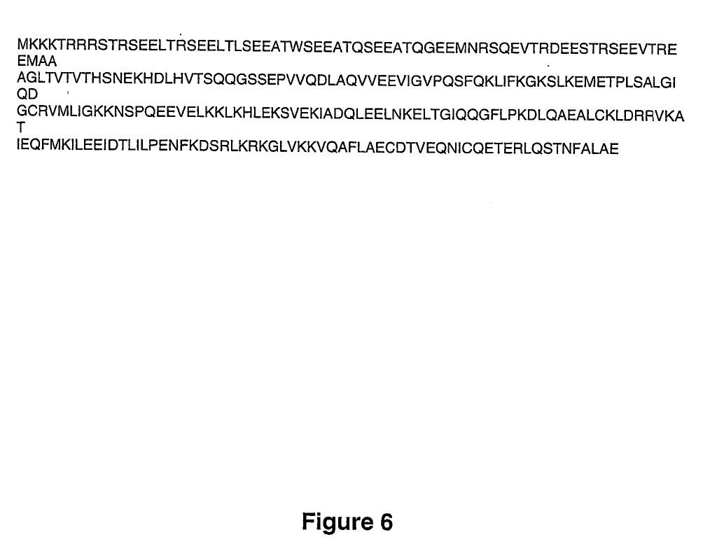

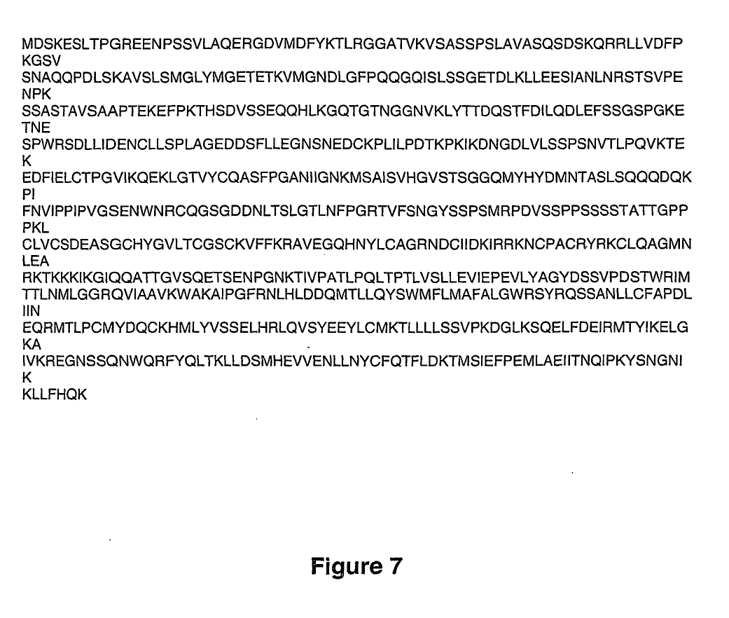

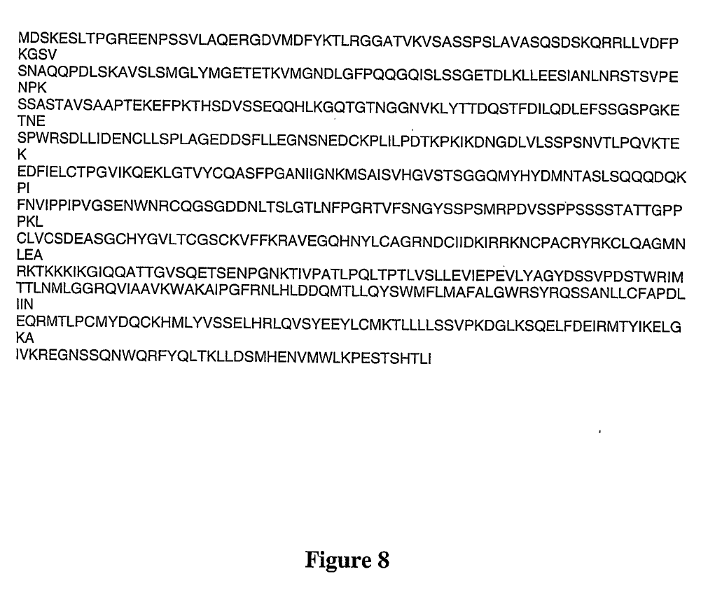

Accordingly, the present invention relates to a method of identifying a compound that inhibits or reduces bag-1 (for a sequence, see FIG. 6) mediated downregulation of glucocorticoid-receptor (GR) transactivation said method comprising the steps of (a) contacting a test compound or a plurality of test compounds with (aa) a (poly)peptide comprising the motif X-Lys-Lys-Lys-Y-Arg-Arg-Arg wherein X and Y represent 0, 1, 2, 3, 4, 5 or 6 amino acids and wherein said amino acids allow binding of the motif to double-stranded DNA; and (ab) a double-stranded DNA under conditions that allow binding of said (poly)peptide to said DNA in the absence of said test compound or said plurality of test compounds; and assessing whether binding of said (poly)peptide to said DNA occurs in the presence of said test compound or said plurality of test compounds wherein inhibition or reduction of binding is indicative of the test compound(s) being suitable to inhibit or reduce bag-1 mediated downregulation of GR transactivation (including transactivation of all GR isoforms throughout this specification, preferably GRα transactivation; for a specific sequence, see FIG. 7; however, also including GRβ transactivation; for a specific sequence, see FIG. 8).

The term “transactivation” means in accordance with the present invention enhancement of the rate of transcription from a gene promoter by a transactivator, for example, GR. In accordance with the present invention the terms “glucocorticoid-receptor transactivation” or “GR transactivation” define the same phenomenon as “glucocorticoid-receptor-mediated transactivation” or “GR-mediated transactivation” and are used herein as synonyms.

The term “plurality of test compounds” is intended to mean, in accordance with the present invention, at least two test compounds such as 3, 4, 5, 6, 7, 8, 10 or 20, 50, 100, 200, 500 or 1000 or more test compounds. The number of test compounds comprised in such plurality of test compounds may be significantly higher such as amounting to 10⁴, 10⁵, 10⁶ or more different compounds which may, for example, derive from a library of cDNAs or a collection of small molecules.

The term “(poly)peptide” denotes both peptides and polypeptides (proteins) wherein, according to a common understanding in the art, the length of peptides is limited to molecules up to about 30 amino acids.

The term “comprising” has, in accordance with the present invention two different meanings: The first meaning is “consisting of”. For example, in connection with the recited motif the term comprising would then mean that the (poly)peptide consists of the modif. The second meaning denotes a surplus over the actually cited technical feature. In the example of the motif, additional amino acids N- or C-terminally thereof would be envisaged.

As regards the above recited motif, it is understood that it comprises two variables X and Y as well as the trimeric lysine and arginine repeats. Both X and Y may represent between 0 and 6 amino acids. Advantageous embodiments are particularly those wherein Y represents between 0 and 3 amino acids. If X and/or Y represent more than 1 amino acid, these amino acids may be the same or different. X preferably represents one amino acid. It may also be bound to a complete protein that forms a fusion protein together with the (poly)peptide comprising the remainder of the motif. In any case, it is required that the capability of the motif to bind to double-stranded DNA is retained. In this regard and in accordance with the present invention, inclusion of the E₂X₄ motif, as suggested by the prior art, into the (poly)peptide is not required. Retainment of binding is easily ascertained. For example, binding to any DNA sequence can be assessed by the Biacore technique, electrophoretic mobility shift assays, filter binding assay, or by binding of DNA to immobilzed protein or vice versa.

The term “suitable to inhibit [. . . ] bag-1 mediated downregulation of GR transactivation” indicates that downregulation is inhibited to 100% or close to 100%. The term .“suitable to [. . . ] reduce bag-1 mediated downregulation of GR transactivation” indicates that downregulation is reduced at least 30% preferably at least 50% and more preferred at least 70%. If a close to 100% or a 100% reduction is achieved, the meanings of the term “reduction” and “inhibition” overlap or are identical.

In accordance with the method of the present invention, the contacting of the test compound(s) with the (poly)peptide and the double-stranded DNA molecule (which comprises preferably at least 23 nucleotides per strand) is effected under conditions that allow binding of said (poly)peptide to said DNA in the absence of said test compound. The various compounds contacted may be put together at the same time, one after the other wherein a certain order is not required or two at a time. The same holds true for the further embodiments of the invention described below wherein also more than two compounds may be contacted at a time and the other compounds, as above, earlier as later.

Suitable conditions are determined by the skilled artisan without further ado. For example, testing may be effected under physiological conditions. Buffers that may be employed to ascertain such physiological conditions include phosphate buffers having a pH value of about 7.0. Any technique that allows determination of binding to any DNA sequence, e.g. the Biacore technique, electrophoretic mobility shift assays, or by binding of DNA to immobilzed protein or vice versa, can be used to verify DNA binding under physiological conditions, e.g. phosphate buffered saline with a pH of 7.0-7.5 and 150 mM salt (NaCl+KCl).

If a plurality of test compounds is contacted with said (poly)peptide and said double-stranded DNA and inhibition of binding is observed this usually means that one or a few members of the plurality of compounds will be causative for said inhibition. In other terms, said compound will bind to the DNA-binding motif of bag-1 and thus interfere with binding of bag-1 to DNA.

It has been surprisingly found in accordance with the present invention that deletion of the entire E₂X₄ motif domain does not affect the ability of BAG-1 to counter GR-dependent transcription. Further surprisingly, it was discovered in accordance with the present invention that a small DNA binding domain comprising the above-recited motif is necessary for inhibition of GR function. Specifically, the first eight amino acids of BAG-1 or a motif related thereto and recited herein above are/is required for the inhibitory effect of BAG-1 on GR, while the E₂X₄ domain is dispensable. The observations made in accordance with the invention are particularly surprising since the art described a general transcription enhancing capability to the bag-1 related motif (Zeiner et al. 1999) which contrasts the inhibition of GR transactivation observed here. Moreover, the binding of BAG-1 to DNA is due to the positive electric charge at the N-terminus. Mutations that inhibit binding to DNA can not be functionally rescued by overexpressing BAG-1 with a point mutation abolishing its interaction with hsp70, indicating that the DNA binding and the hsp70 interaction domain must be present in cis.

This DNA binding domain is uncommon for transcriptional regulatory proteins, because DNA binding appears to be non-specific (Zeiner et al., 1999). The non-specificity of DNA binding is in line with the observation made in accordance with the invention that spacing of the two positively charged stretches of three lysines and three arginines is not important for DNA binding. This suggests an interaction with DNA via ionic interactions of these positive charges with the negatively charged phosphate backbone of DNA.

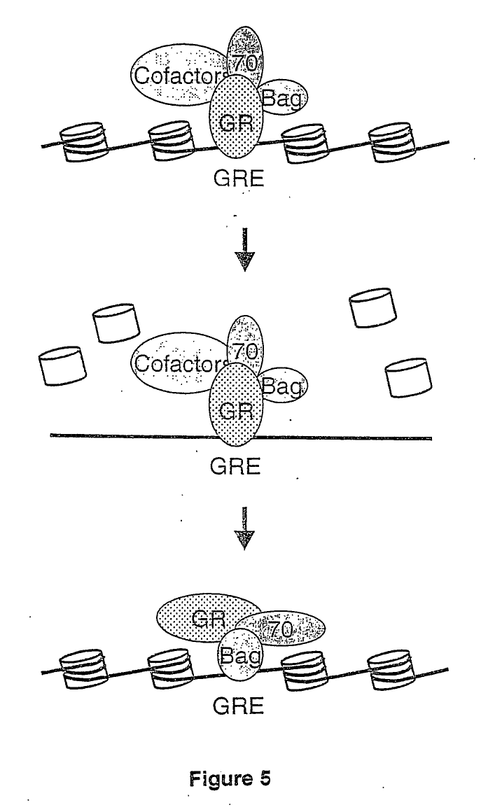

In accordance with the above, identification of a compound that inhibits the binding of the recited motif to said double-stranded DNA is immediately indicative of this compound being useful as an inhibitor of bag-1 mediated down-regulation of GR transactivation.

Whereas the applicant does not wish to be bound by any scientific theory, the following model is proposed to account for the effects (FIG. 5): BAG-1 is transported into the nucleus along with GR upon activation of the receptor with hormone (Schneikert et al., 2000). GR interacts with the chromatin at glucocorticoid response elements. The first step in GR-mediated transactivation presumably is remodelling of the local chromatin structure by cofactors recruited by GR (Freedman, 1999). Once the chromatin is restructured, BAG-1 gains access to the DNA, which interfers with the further functions of GR for efficient transactivation. Access of BAG-1 to the DNA might be promoted by the rapid exchange with regulatory sites of GR (McNally et al., 2000).

BAG-1 would not be the only non-specifically DNA binding factor, which binds to specific places on the chromosome by virtue of associating with other factors. Another example is cdc6, an essential protein in yeast which is recruited to yeast replication origins in G1 by another replication factor, origin recognition complex protein 1 (Wang, Feng, et al. 1999). It is intriguing not only that cdc6 alone binds non-specifically to DNA, but also that site-directed mutagenesis identified the basic protein motif KRKK as essential for DNA binding and function of the protein (Feng, Wang, et al. 2000). Apparently, this motif is very similar to the basic motif of the N-terminus of BAG-1, which is demonstrated in accordance with the present invention to be not only essential for binding to DNA, but also for functional integrity with respect to the inhibition of GR-dependent transcription.

The method of the invention allows for the identification of compounds that will immediately (if formulated as a drug) or eventually (if used as a lead compound) give rise to medicaments that are useful in the reduction of adverse side effects caused by glucocorticoid therapy. Specifically, the effects desired by the glucocorticoid therapy may be retained in quantitatively undiminished form whereas the adverse side effects are significantly reduced, if a medicament developed on the basis of the present invention is administered in conjunction with the glucocorticoids. Further, the compounds may be effectively used in the therapy of tumors, in the generation or progression of which activated androgen receptor or estrogen receptor plays a role. Thus, it has been shown that the androgen receptor is upregulated by bag-1 (Knee et al. 2001). In addition, it has been shown that higher levels of bag-1 are positively correlated with enhanced survival rates of breast cancer. In so far, breast cancer is an embodiment of the tumors mentioned above. Additionally, in further approaches the compound may replaced by the glucocorticoid in therapy.

In a preferred embodiment of the method of the invention, said motif recited in (aa) is located at the N-terminus of said (poly)peptide.

In this embodiment, the location of the motif within the (poly)peptide is identical to its location within bag-1. This embodiment allows a particularly convenient identification of suitable compounds due to its reliance on the naturally occurring situation.

In another preferred embodiment of the method of the invention, said DNA carries a readout-system that is activated by the binding of said (poly)peptide to said DNA.

The term “read-out system” means an experimental set up that allows easy detection (“read-out”) of a biological parameter of interest. For example, when electrophoretic mobility shift assays are used to determine binding of peptides or proteins to DNA, the biological parameter of interest would be DNA binding and the read out would be the shifted radioactive bands on an acrylamide gel, as detected be autoradiography or an imaging system. The experimental set up would include incubation of protein and (labelled) DNA in a suitable buffer, loading on and electrophoresis through an acrylamide gel followed by autoradiography.

Preferably, by said read-out system the modulation of a signal is measured in the presence or absence of said compound. Thus, the modulation of the measured signal indicates whether said compound is suitable for the downregulation of GR-mediated transactivation.

In accordance with this preferred embodiment of the method, binding and consequently identification of compounds is rendered particularly easy. In particular, the read-out system indicates whether a prima facie suitable compound has prevented binding of bag-1 to the DNA or not. In order to eliminate false positive signals, further tests may be necessary. Employing such tests is within the common knowledge of the person skilled in the art. Further embodiments of such read-out systems are described in the appended examples.

In addition, the present invention relates a method of identifying a compound that inhibits or reduces bag-1 mediated downregulation of glucocorticoid-receptor transactivation said method comprising the steps of (a) contacting a test compound or a plurality of test compounds with (aa) a (poly)peptide comprising the motif of X-Lys-Lys-Lys-Y-Arg-Arg-Arg preferably at its N-terminus wherein X and Y represent 0, 1, 2, 3, 4, 5 or 6 amino acids; and a domain that is the hsp70 binding domain of bag-1 or functionally equivalent; (ab) polypeptide representing the GR or a functionally equivalent molecule; and (ac) double-stranded DNA molecule comprising a binding site for the GR under conditions that allow the formation of a functional (poly)peptide complex consisting of said (poly)peptides recited in (aa) to (ab) and binding of said polypeptide recited in (ab) with said double-stranded DNA molecule in the absence of said test compound or said plurality of test compounds; and (ba) assessing whether said polypeptide recited in (ab) binds to said double-stranded DNA wherein an increase of binding is indicative of the test compound(s) being suitable to inhibit or reduce bag-1 mediated downregulation of GR transactivation; or (bb) assessing whether said complex formation and/or DNA-binding recited in (ac) results in a transactivation of GR wherein an increased level of transactivation is indicative of the test compound(s) being suitable to inhibit or reduce bag-1 mediated downregulation of GR transactivation.

As regards the above recited motif, it is understood, as already defined for the embodiments above, that it comprises two variables X and Y as well as the trimeric lysine and arginine repeats. Both X and Y may represent between 0 and 6 amino acids. Advantageous embodiments are particularly those wherein Y represents between 0 and 3 amino acids. If X and/or Y represent more than 1 amino acid, these amino acids may be the same or different. X preferably represents one amino acid. It may also be bound to a complete protein that forms a fusion protein together with the (poly)peptide comprising the remainder of the motif. In any case, it is required that the capability of the motif to bind to double-stranded DNA is retained.

The terms “increase of binding” and “increased level of transactivation” refer to increases of at least 25%, preferably at least 50%, more preferred at least 75% and most preferred at least 100% of the initial level.

This embodiment of the present invention does not rely on the interference of binding of the above-recited motif to DNA but is equally effective in the identification of compounds for the above-recited purpose. Rather, this embodiment measures directly the interaction of a polypeptide representing GR or of a molecule functionally equivalent thereof with its target DNA which requires a specific binding site for the GR and is thus, as a rule, different from the DNA that is used as a substrate for assessing binding by the motif. What is required in accordance with this assay of the present invention are the compounds that are recited under items (aa) to (ac); supra. As regards the (poly)peptide recited in item (aa), the same definition that was used in accordance with the main embodiment of this invention applies. In addition, the (poly)peptide comprises the hsp 70 binding domain of bag-1 or a functionally equivalent domain. The hsp70 binding domain of human bag-1M comprises amino acids 151-264 (Sondermann et al. 2001) of the naturally occurring molecule. A functionally equivalent domain is also capable of binding to hsp 70. For example, such a functionally equivalent domain may be derived from the naturally occurring domain by an exchange of conservative amino acids. Furthermore, amino acids not comprised in the binding pocket may be exchanged for different amino acids with the proviso that that binding is essentially retained (or even increased). Even amino acids contributing to the binding site for hsp 70 may be exchanged as long as the resulting domain retains the capacity of binding to hsp 70. An exchange of amino acids may be effected by use of different methods. For example, site directed mutagenesis may be employed on the DNA basis (see, e.g., Sambrooke et al., “Molecular Cloning, A Laboratory Manual”, CSH Press, Cold Spring Harbor 1989). Once an amino acid exchange has been effected, the resulting molecule would be tested for its binding capacity for hsp 70. Appropriate test systems are available in the art or may be derived from this specification. Functionally equivalent domains may also be characterised by the detection of amino acids and/or the insertion of additional amino acids.

With respect to the (poly)peptide mentioned in item (ab) either the glucocorticoid receptor itself or a functionally equivalent molecule may be employed. Minimal requirements for a functional equivalent of GR are the DNA binding domain of GR or a functional equivalent thereof, the hinge region of GR or a functional equivalent thereof and a transactivation domain, preferably one or both transactivation domains of GR (Hollenberg (1988); Mangelsdorf (1995); Savory (2001)). As regards the isolation of functionally equivalent molecules, the considerations made in connection with the hsp 70 binding domain apply in a corresponding manner here.

Binding sites for the GR have been described in the art, e.g. by Beato et al. (1989). It is understood that the natural binding site for GR may be altered in the DNA molecule recited in (ac) as long as its binding capacity for the GR is retained. Alterations may be, for example, effected by site-directed mutagenesis (see above) whereupon a binding assay for GR is carried out. Binding of GR to DNA can be assessed in essence the same way binding of the polypeptide to DNA is assessed, i.e. by using the Biacore technique, electrophoretic mobility shift assays, filter binding assay, or binding of DNA to immobilzed protein or vice versa. Apart from its double-stranded nature, the presence of a GR binding site is the only necessary requirement for the DNA molecule recited in (ac). Preferably, said DNA molecule comprises at least 25 nucleotides per strand

Conditions that allow complex formation as required by feature (ac) can be established by the skilled artisan without further ado. Appropriate conditions are, for example, physiological conditions. In addition, various binding conditions have been described in the literature, e.g. Chen et al. (1997), Drouin et al. (1993), Gast et al. (1995), Liu et al. (1995), Ou (2001), Schneikert et al. (1999) or Trapp and Holsboer (1996). Among the parameters varied are the pH (around 7.5), concentrations of NaCl, KCl, EDTA, EGTA, Nonidet P40, dithiothreitol or 2-mercaptoethanol, glycerol, poly (dIdC), bovine serum albumine, steroid hormone etc. In addition, different protocols have been used to prepare cell extracts containing the glucocorticoid receptor.

In accordance with this embodiment of the present invention, an appropriate compound that inhibits or reduces bag-1 mediated downregulation of GR may be detected by way of two different read-out systems represented by options (ba) and (bb). In the first option, binding of the polypeptide representing GR (or of a functionally equivalent molecule) to the double-stranded DNA is measured (as regards suitable methodology see above). An increase in binding is indicative of the compound having the desired property. According to the second option, GR mediated transactivation is preferably measured in reporter gene assays in cultivated eukaryotic cells.

In a preferred embodiment of the method of the invention, said (poly)peptides recited in steps (aa) and (ab) and said double-stranded DNA molecule are further contacted with (ad) a (poly)peptide comprising the bag-1 binding domain of hsp 70 or a functionally equivalent domain and the GR binding domain of hsp 70 or a functionally equivalent domain;

In this preferred embodiment of the invention, use is made of an additional compound in the complex formation. The further polypeptide comprises two domains having a defined specificity. If the naturally occurring domains are not employed, then functionally equivalent domains may be selected in a corresponding manner as was described for the hsp 70 binding domain of bag-1 herein above. If this and the further (poly)peptides described above are non-naturally occurring (poly)peptides, functionality of the domains is nevertheless easily ascertained. For example, functional domains may be linked by a flexible linker as is used, for example, in the generation of scFv fragments. Consequently, the complex formation relies on four different compounds known to be capable of interaction with one another via specific binding domains. By adding hsp70 to the system, compounds can be screened that disrupt binding of bag-1 to hsp70.

Another preferred embodiment of the invention relates to a method wherein the amino acids X and Y comprised in the (poly)peptide recited in (aa) allow binding of the motif to a double-stranded DNA.

This preferred embodiment envisages that the bag-1 derived motif binds to DNA. As with the main embodiment of this invention, amino acids (if any) represented by X and Y support or at least do not prevent said binding.

In an additional preferred embodiment of the invention said test compound or plurality of test compounds is/are further contacted with a double-stranded DNA molecule that does not comprise a binding site for GR.

This embodiment of the invention is particularly advantageous since it allows not only for assessing modulation of GR transactivation by the compound to be tested but also for investigating whether said compound inhibits binding of the motif to DNA. In this way, compounds having the desired effect which inhibit or do not inhibit binding of the motif may be differentiated. For example, it is determined whether the effect of a compound that inhibits or reduces bag-1 mediated downregulation of GR is the result of an inhibition or reduction of the binding of bag-1 to DNA or the result of binding to the recited motif of bag-1 only. In the latter case, it may be possible that the compound-bag-1 complex still has the ability to bind to DNA. However, the binding of the compound to the recited motif may result, e.g. in a change of the conformation of bag-1 and, thus, implicate an inhibition or reduction bag-1 mediated downregulation of GR.

Said double-stranded DNA molecule recited in (ac) further carries a readout-system that is activated upon binding of said GR to said DNA as it is shown in a further preferred embodiment of the invention.

In an additional preferred embodiment of the invention said readout-system comprises a reporter gene.

The term “reporter gene” is used in the context of the invention as a term for a coding unit (gene) whose encoded product (protein) can be easily assayed (see Glossary of Levin, Genes V, 1994, page 1252). Such a reporter gene may be connected to any promoter of interest so that expression of the gene can be used to assay the function of the promoter used. In line with the present invention the term “reporter gene” also comprises nucleotide sequences coding for fragments of proteins or fusion proteins as long as the promoter dependent expression of said genes can be measured in a corresponding assay. Examples for a gene which can be used as a “reporter gene” are known by a person skilled in the art and found in the literature, e.g. Mühlhardt, Der Experimentator: Molekularbiologie, Gustav Fischer Verlag 1999.

In a particularly preferred embodiment of the invention said reporter gene is selected from a group consisting of firefly luciferase, renilla luciferase, β-galactosidase, human growth hormon (hGH), GFP or another fluorescent protein, CAT (chloramphenicolacetyltransferase), alkaline phosphotase including SEAP (secreted alkaline phosphatase), TAT (tyrosyl aminotransferase) and peroxidase.

Examples for assays to measure the expression of said reporter genes are known to a person skilled in the art and described, e.g, in Bronstein et al. (1994), Lewis et al. (1998), Naylor (1999), Schenborn and Groskreutz (1999) or Silverman et al. (1998). Said reporter gene is a gene encoding a transmembrane protein as required in a another particularly preferred embodiment of the invention.

As stated in a most particularly preferred embodiment of the invention said transmembrane protein is a receptor polypeptide.

The expression of said transmembrane protein may be detected by use of conventional protocols of flow cytometry, histology or other assay systems are known to a person skilled in the art.

Said test compound(s) is/are selected from the group of small molecules, peptides, aptamers and antibodies or fragments or derivatives thereof in accordance with a further preferred embodiment of the invention.

The term “aptamers” is well known in the art and described, e.g. in Brody and Gold (2000), Jayasena (1999) or Osborne et al. (1997). Aptamers are preferably single stranded nucleic acid molecules that bind to another molecule as a consequence of their three-dimensional structure. Insofar, aptamers have a similar function as antibodies.

“Fragments or derivatives” of antibodies are molecules that retain the binding specificity of the antibodies. Examples of fragments are Fab or F(ab₂)′ molecules. An example of a derivative is an scFv molecule.

In another particularly preferred embodiment of the invention said small molecules are small organic molecules.

Another particularly preferred embodiment shows relates to a method wherein peptides are derived from an at least partially randomized peptide library. Such at least partially randomized peptide libraries have been described, e.g. in Dolle (2000), Hoppe-Seyler and Butz (2000), Irving et al. (2001) or Kay et al. (2001).

According to a further particularly preferred embodiment of the invention, said antibodies are monoclonal antibodies.

A further preferred embodiment of the invention relates to a method wherein, if a plurality of test compounds is tested,
(a) different members of said plurality of test compounds are tested in different reaction vessels wherein those reaction vessels that do not contain test compounds indicative of being suitable to inhibit or reduce bag-1 mediated downregulation of GR transactivation are not further considered;
(b) members contained in reaction vessels that test positive with regard to inhibition or reduction of bag-1 mediated downregulation of GR transactivation are redistributed into different reaction vessel and tested again; and optionally
(c) step (b) is repeated until a single compound is identified that is suitable to inhibit or reduce bag-1 mediated downregulation of GR transactivation.

In this preferred embodiment of the method of the invention, suitable test compounds will be identified step by step, if a variety of test compounds is assayed for the desired activity wherein this variety (i.e. at least two different compounds) are contained in the same lot/reaction vessel. Suitable reaction results include wells of microtiter plates wherein said microtiter plates may have, e.g., 96, 384 or 1536 wells. Reaction vessels not further considered or their contents are usually discarded wherein the required safety standards would be considered.

The assessment referred to above may be effected in an in vitro transcription/translation system. In this context in vitro systems using bacteriophage based systems are preferred. More preferably said bacteriophage based systems using the T7, T3 or Sp6 promoter in accordance with another preferred embodiment of the invention.

It is known in the art that well established eukaryontic in vitro translation systems, e.g. rabbit reticulocyte lysate, wheat germ extract or frog egg extracts, require further adaptations, all within the knowledge of the skilled artesian for the analysis of GR mediated transactivation of gene/protein expression. Further systems for analysis of said transactivation, e.g. on the level of transcription, using eukaryontic promoters will become suitable for the above described in vitro systems after further adaptation. For example Ohashi et al. (1994) report of a system using yeast extract, Macias and Stinski (1993) established a system using HeLa cells and Pichon and Christophe (1998) described systems using animal tissue. It is state of the art that said systems require extensive synthesis and isolation of different transcription factors (Mittler et al. 2001). Thus, further adaption of said systems to the method of the invention is required which is, as stated above, well within the capability of the skilled artesian and require no undue burden of work.

In a further preferred embodiment of the method of the present invention, the assessment is effected in an eukaryotic cell or tissue or an extract thereof. Suitable eukaryotic cells include immortalized tumor cell lines, listed for example in the catalogues of ATCC and ETCC, in particular, cell lines that proved to be useful are HeLa, Cos-1, Cos-7, SK-N-MC, and CV-1.

An extract may be obtained from yeast (see, e.g. Ohashi et al. 1994). The approach employing tissue may make use of the system described in Pichon and Christophe (1998). Further guidiance in this regard is available from Mittler et al. (2001).

The invention relates in another preferred embodiment to a method wherein X is Met. The recited abbreviations are in accordance with the standard denomination for amino acids. Thus, Met stands for methionine, Thr for threonine, Ala for alanine.

According to another preferred embodiment, the invention also relates to a method wherein Y is Thr.

In a further preferred embodiment the invention relates to a method wherein Y is 0.

In another preferred embodiment of the method of the invention, Y is Ala-Thr.

Another preferred embodiment of the invention relates to a method wherein Y is Ala-Ala-Thr.

According to a particularly preferred embodiment of the invention, said (poly)peptide which comprises the motif X-Lys-Lys-Lys-Y-Arg-Arg-Arg is bag-1.

Said (poly)peptide recited in step (ad) is hsp70 in accordance with another particularly preferred embodiment of the invention.

The present invention also relates in another preferred embodiment to a method further comprising refining a compound which was identified by any of the above methods of the invention comprises the steps of:
(i) identification of the binding site of said compound binding to said motif and optionally of the binding site of said motif binding to said compound;
(ii) molecular modeling of the binding site of the compound and optionally of the motif; and
(iii) modification of the compound to improve its binding specificity for the motif.

All techniques employed in the various steps of the method of the invention are conventional or can be derived by the person skilled in the art from conventional techniques without further ado. Thus, biological assays based on the herein identified nature of the compounds may be employed to assess the specificity or potency of the (pro)drugs (i.e. compound) wherein the increase of the one or more desired activities of the compounds may be used to monitor said specificity or potency. Steps (1) and (2) can be carried out according to conventional protocols. A protocol for site directed mutagenesis is described in Ling M M, Robinson B H. (1997) Anal. Biochem. 254: 157-178. The use of homology modelling in conjunction with site-directed mutagenesis for analysis of structure-function relationships is reviewed in Szklarz and Halpert (1997) Life Sci. 61:2507-2520. Chimeric proteins are generated by ligation of the corresponding DNA fragments, e.g. via a unique restriction site using the conventional cloning techniques described in Sambrook, Fritsch, Maniatis. Molecular Cloning, a laboratory manual. (1989) Cold Spring Harbor Laboratory Press. A fusion of two DNA fragments that results in a chimeric DNA fragment encoding a chimeric protein can also be generated using the gateway-system (Life technologies), a system that is based on DNA fusion by recombination. A prominent example of molecular modelling is the structure-based design of compounds binding to HIV reverse transcriptase that is reviewed in Mao, Sudbeck, Venkatachalam and Uckun (2000). Biochem. Pharmacol. 60:1251-1265.

For example, identification of the binding site of said (pro)drug by site-directed mutagenesis and chimerical protein studies can be achieved by modifications in the (poly)peptide primary sequence (if the compound is a (poly)peptide) that affect the drug affinity; this usually allows to precisely map the binding pocket for the drug.

As regards step (2), the following protocols may be envisaged: Once the effector site for (pro)drugs has been mapped, the precise residues interacting with different parts of the drug can be identified by combination of the information obtained from mutagenesis studies (step (1)) and computer simulations of the structure of the binding site provided that the precise three-dimensional structure of the (pro)drug is known (if not, it can be predicted by computational simulation). If said (pro)drug is itself a peptide, it can be also mutated to determine which residues interact with other residues in the (poly)peptide comprising the motif.

Finally, in step (3) the (pro)drug can be modified to improve its binding affinity or ist potency and specificity. If, for instance, there are electrostatic interactions between a particular residue of the (poly)peptide comprising the motif and some region of the compound (pro)drug molecule, the overall charge in that region can be modified to increase that particular interaction.

Identification of binding sites may be assisted by computer programs. Thus, appropriate computer programs can be used for the identification of interactive sites of a compound and the (poly)peptide comprising the motif by computer assisted searches for complementary structural motifs (Fassina, Immunomethods 5 (1994), 114-120). Further appropriate computer systems for the computer aided design of protein and peptides are described in the prior art, for example, in Berry, Biochem. Soc. Trans. 22 (1994), 1033-1036; Wodak, Ann. N.Y. Acad. Sci. 501 (1987), 1-13; Pabo, Biochemistry 25 (1986), 5987-5991. Modifications of the (pro)drug can be produced, for example, by peptidomimetics and other compounds having the same properties can also be identified by the synthesis of peptidomimetic combinatorial libraries through successive chemical modification and testing the resulting compounds. Methods for the generation and use of peptidomimetic combinatorial libraries are described in the prior art, for example in Ostresh, Methods in Enzymology 267 (1996), 220-234 and Dorner, Bioorg. Med. Chem. 4 (1996), 709-715. Furthermore, the three-dimensional and/or crystallographic structure of compounds identified by the method of the invention can be used for the design of peptidomimetic activators, e.g., in combination with the (poly)peptide of the invention (Rose, Biochemistry 35 (1996), 12933-12944; Rutenber, Bioorg. Med. Chem. 4 (1996), 1545-1558).

Another preferred embodiment of the invention relates to a method further comprising refining a compound as identified or refined herein above comprising:
(a) modeling said compound by peptidomimetics; and
(b) chemically synthesizing the modeled compound.

In a further preferred embodiment the invention relates to a method further comprising modifying a compound identified or refined by the methods as described herein above comprising attaching said compound to a signal peptide. Said signal peptide is characterized by its ability to increase the rate of incorporation of the compound into a cell. Examples for said signal peptides are know in the art and described, e.g. in Fischer et al. (2000), Lindgren et al. (2000) or Service (2000).

The invention in another preferred embodiment furthermore relates to a method also comprising modifying a compound identified or refined by the method as described herein above as a lead compound to achieve (i) modified site of action, spectrum of activity, organ specificity, and/or (ii) improved potency, and/or (iii) decreased toxicity (improved therapeutic index), and/or (iv) decreased side effects, and/or (v) modified onset of therapeutic action, duration of effect, and/or (vi) modified pharmakinetic parameters (resorption, distribution, metabolism and excretion), and/or (vii) modified physico-chemical parameters (solubility, hygroscopicity, color, taste, odor, stability, state), and/or (viii) improved general specificity, organ/tissue specificity, and/or (ix) optimized application form and route by (i) esterification of carboxyl groups, or (ii) esterification of hydroxyl groups with carbon acids, or (iii) esterification of hydroxyl groups to, e.g. phosphates, pyrophosphates or sulfates or hemi succinates, or (iv) formation of pharmaceutically acceptable salts, or (v) formation of pharmaceutically acceptable complexes, or (vi) synthesis of pharmacologically active polymers, or (vii) introduction of hydrophylic moieties, or (viii) introduction/exchange of substituents on aromates or side chains, change of substituent pattern, or (ix) modification by introduction of isosteric or bioisosteric moieties, or (x) synthesis of homologous compounds, or (xi) introduction of branched side chains, or (xii) conversion of alkyl substituents to cyclic analogues, or (xiii) derivatisation of hydroxyl group to ketales, acetates, or (xiv) N-acetylation to amides, phenylcarbamates, or (xv) synthesis of Mannich bases, imines, or (xvi) transformation of ketones or aldehydes to Schiff's bases, oximes, acetales, ketales, enolesters, oxazolidines, thiozolidines or combinations thereof.

The various steps recited above are generally known in the art. They include or rely on quantitative structure-action relationship (QSAR) analyses (Kubinyi, “Hausch-Analysis and Related Approaches”, VCH Verlag, Weinheim, 1992), combinatorial biochemistry, classical chemistry and others (see, for example, Holzgrabe and Bechtold, Deutsche Apotheker Zeitung 140 (8), 813-823, 2000).

In another preferred embodiment, the invention relates to a method further comprising producing a pharmaceutical composition comprising the step of formulating one or more of the compounds identified or refined by any of the above methods with a pharmaceutically acceptable carrier or diluent.

The pharmaceutical composition produced in accordance with the present invention may comprise a pharmaceutically acceptable carrier and/or diluent. Examples of suitable pharmaceutical carriers are well known in the art and include phosphate buffered saline solutions, water, emulsions, such as oil/water emulsions, various types of wetting agents, sterile solutions etc. Compositions comprising such carriers can be formulated by well known conventional methods. These pharmaceutical compositions can be administered to the subject at a suitable dose. Administration of the suitable compositions may be effected by different ways, e.g., by intravenous, intraperitoneal, subcutaneous, intramuscular, topical, intradermal, intranasal or intrabronchial administration. The dosage regimen will be determined by the attending physician and clinical factors. As is well known in the medical arts, dosages for any one patient depends upon many factors, including the patient's size, body surface area, age, the particular compound to be administered, sex, time and route of administration, general health, and other drugs being administered concurrently. A typical dose can be, for example, in the range of 0.001 to 1000 μg (or of nucleic acid for expression or for inhibition of expression in this range); however, doses below or above this exemplary range are envisioned, especially considering the aforementioned factors. Generally, the regimen as a regular administration of the pharmaceutical composition should be in the range of 1 μg to 10 mg units per day. If the regimen is a continuous infusion, it should also be in the range of 1 μg to 10 mg units per kilogram of body weight per minute, respectively. Progress can be monitored by periodic assessment. Dosages will vary but a preferred dosage for intravenous administration of DNA is from approximately 10⁶ to 10¹² copies of the DNA molecule. The compositions of the invention may be administered locally or systemically. Administration will generally be parenterally, e.g., intravenously; DNA may also be administered directly to the target site, e.g., by biolistic delivery to an internal or external target site or by catheter to a site in an artery. Preparations for parenteral administration include sterile aqueous or non-aqueous solutions, suspensions, and emulsions. Examples of non-aqueous solvents are propylene glycol, polyethylene glycol, vegetable oils such as olive oil, and injectable organic esters such as ethyl oleate. Aqueous carriers include water, alcoholic/aqueous solutions, emulsions or suspensions, including saline and buffered media. Parenteral vehicles include sodium chloride solution, Ringer's dextrose, dextrose and sodium chloride, lactated Ringer's, or fixed oils. Intravenous vehicles include fluid and nutrient replenishers, electrolyte replenishers (such as those based on Ringer's dextrose), and the like. Preservatives and other additives may also be present such as, for example, antimicrobials, anti-oxidants, chelating agents, and inert gases and the like. Furthermore, the pharmaceutical composition produced in accordance with the invention may comprise further agents such as interleukins or interferons depending on the intended use of the pharmaceutical composition.

The invention finally relates to the use of a compound identified by the method of the invention or refined by any of the methods recited above for the preparation of a pharmaceutical composition for the prevention or treatment of Cushing syndrome, multiple sclerosis, asthma, arthritis, other inflammatory diseases or depression.

Said pharmaceutical composition may, optionally, comprise one or more pharmaceutically acceptable carrier or diluents, e.g., as have been described herein above.

Examples of other inflammatory diseases are sterile or infectious inflammations such as poststreptococcal autoimmune inflammation (autoimmune nephritis etc.), sepsis, viral and bacterial infections, fungi, parasites, graft rejection.

TABLE 1
Structure of BAG-1M, BAG-1S and the mutants BAG-1MΔN10 and
BAG-1MD11-67. DNA = DNA-binding domain, UBI: Ubiquitin-
like-domain, hsp70-IAD: Hsp70-Interacting-domain, E₂X₄:
E₂X₄-domains.

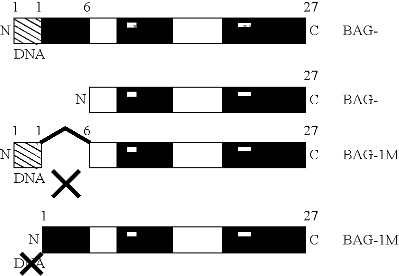

Table 1:
Structure of BAG-1M, BAG-1S and the mutants BAG-1MΔN10 and BAG-1MΔ11-67.
DNA = DNA-binding domain,
UBI: Ubiquitin-like-domain,
hsp70-IAD: Hsp70-Interacting-domain,
E₂X₄: E₂X₄-domains:

TABLE 2
Structure of BAG-1 mutated in the DNA binding domain.

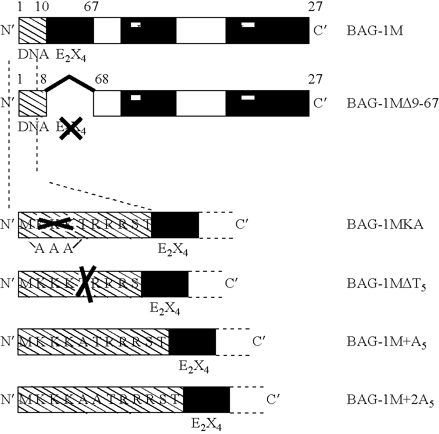

Table 2 Structure of BAG-1M, mutant BAG-1MΔ11-67, and the mutants of the DNA-binding domain of BAG-1, BAG-1MKA, BAG-1M-T5, BAG-1M+A5, BAG-1M+2A5
UBI: Ubiquitin-like-domain,
hsp70-IAD: Hsp7O-Interacting-domain,
E₂X₄: E₂X₄-domains.

The figures show:

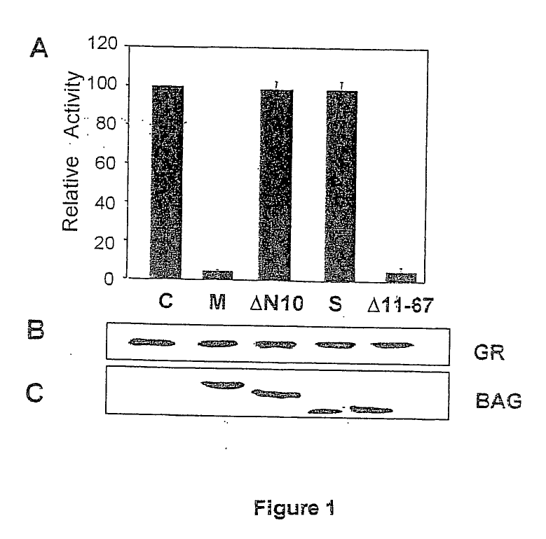

FIG. 1:

Effect of wt BAG-1M, ΔN10 and Δ11-67 on GR-dependent transcription. A SK-N-MC cells were transiently transfected with 3.5 μg of GR-responsive MMTV-luciferase (MTV-Luc) indicator gene, 1 μg of an internal control plasmid encoding renilla luciferase under the control of the SV40-promoter and 4 μg of a human GR-encoding plasmid (pRK7GRHA). In addition, 6 μg of either an empty expression vector (C=control) or the mutants BAG-1MΔN10, BAG-1MΔ11-67 or the isoforms BAG-1M and BAG-1S were cotransfected with a total amount of 14.5 μg transfected plasmid DNA in each sample. Cells were transfected using electroporation, replated and cultured for 24 h in fresh medium either with or without 100 nM dexamethasone. Luciferase activities were corrected by Renilla-luciferase activities and are presented as percent activity with the activity of control vector-transfected cells set as 100%. Results represent mean values±s.e.m. of eight independent experiments performed in sextuplicate. B/C Representative western blot of either GR- or BAG-protein. Whole cell extracts used for luciferase assays were prepared for SDS-PAGE and immunoblotting. Antibodies were directed against either the C-terminus of BAG-1 or the HA-tag on GR.

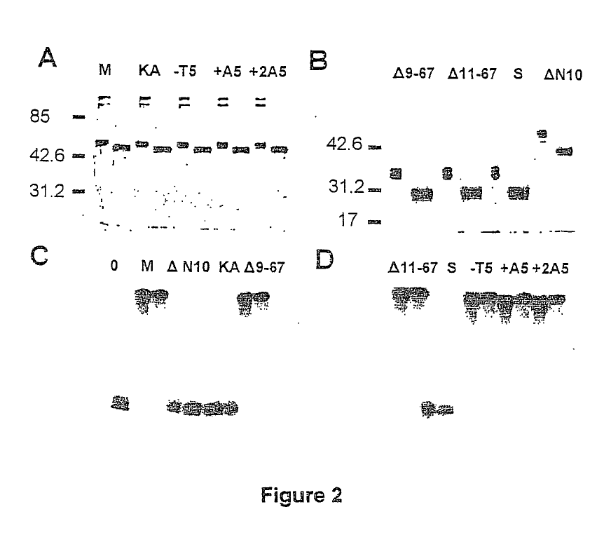

FIG. 2:

A/B Bacterially expressed BAG-1 and mutants. BAG-1 isoforms and mutants were cloned into the bacterial expression vector pProexHTa (Lifetech. Inc., Rockeville, USA) that delivered a histidine-tail to the N-terminus of the proteins. BAG-1M isoforms and mutants were expressed in E. coli, purified using Ni-Agarose columns following the QIAexpressionist protocol (QIAGEN Inc., Hilden, Germany). The histidine-tail was removed by cleaving with tobacco edge virus protease and proteins were analysed by SDS-PAGE 12% and 15%. Staining was performed with Coomassie blue R250. Precleaved and cleaved proteins were applied alternately onto gels. A: BAG-1M=M, BAG-1MKA=KA, BAG-1M-T5=−T5, BAG-1M+A5=+A5, BAG-1M+2A5=+2A5 B: BAG-1MΔ9-67, BAG-1MΔ11-67=Δ11-67, BAG-1S=S, BAG-1MΔN10=ΔN10. C/D DNA-binding of BAG-1M isoforms and mutants. A radiolabeled 125 bp fragment from phage λ-DNA/HINDIII was either employed as such (lane 0) or used for electrophoretic mobility-shift assays with the cleaved proteins, either 1 μg (a-lanes) or 2 μg (b-lanes) were allowed to bind to ³²P-labelled DNA for 30 min. at 25° C. and complexes were separated on an acrylamide gel under native conditions. Shown are representative autoradiograms. C: Full length BAG-1M=M, BAG-1MKA=KA, BAG-1M=ΔN10, BAG-1MΔ9-67=Δ9-67 and D: BAG-1MΔ11-67=Δ11-67, BAG-1S=S, BAG-1M-T5=−T5, BAG-1M+A5=+A5, BAG-1M+2A5=+2A5.

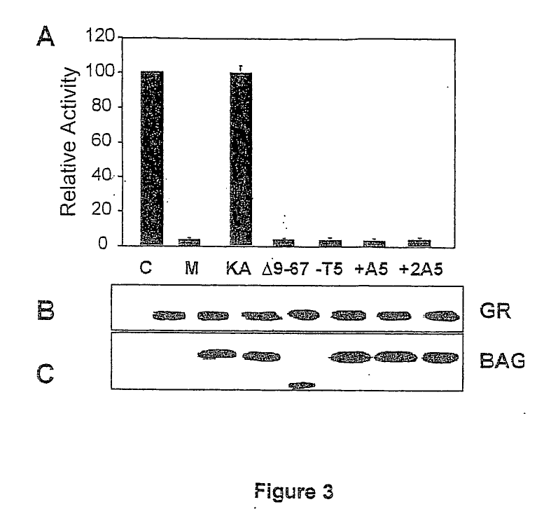

FIG. 3:

DNA binding-defective mutants are unable to inhibit GR. A SK-N-MC cells were transiently transfected with 3.5 μg of GR-responsive MMTV-luciferase (MTV-Luc) indicator gene, 1 μg of an internal control encoding renilla luciferase under the control of the SV40-promoter and 4 μg of a human GR-encoding plasmid (pRK7GRHA). In addition, 6 μg of either an empty expression vector (C=control) or the mutants BAG-1MKA, BAG-1MΔ9-67 BAG-1M+A5 BAG-1M+2A5 BAG-1M-T5 resp. the wildtype BAG-1M were cotransfected, with the total amount of 14.5 μg transfected plasmid DNA in each sample. Cells were transfected by electroporation, replated and cultured for 24 h in fresh medium either with or without 100 nM dexamethasone. Luciferase activities were corrected by Renilla-luciferase activities and are presented as percent activity with the firefly-luciferase activity of control vector-transfected cells set as 100%. Results represent mean values±s.e.m. of six independent experiments performed in sextuplicate. B/C Representative western blot of either GR- or BAG-protein. Whole cell extracts used for luciferase assays were prepared for SDS-PAGE and immunoblotting. Antibodies were directed against either the C-terminus of BAG or the HA-tag on GR.

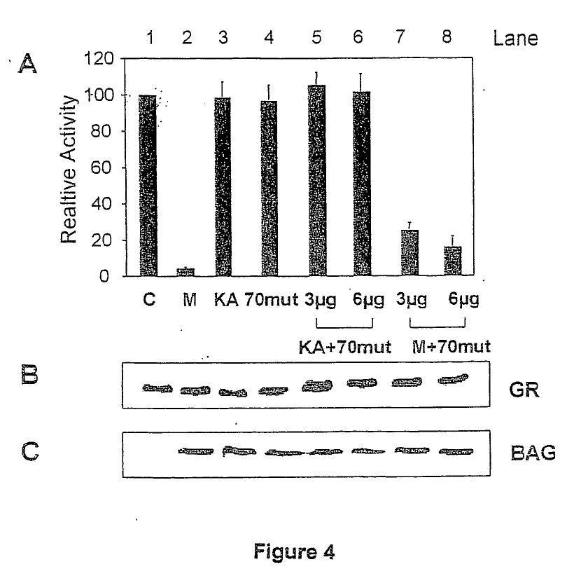

FIG. 4:

The DNA binding domain and the hsp70 interaction domain of BAG-1 need to be present in cis. A SK-N-MC cells were transiently transfected with 3.5 μg of GR-responsive MMTV-firefly luciferase (MTV-Luc) indicator gene, 2.5 μg of an internal control plasmid encoding β-galactosidase (pCMVβGal) under the control of the CMV-promoter and 4 μg of a human GR-encoding plasmid (pRK7GRHA). In addition, 6 μg of either an empty expression vector (C=control) or the mutants BAG-1Mhsp70mut (here: 70mut), BAG-1MKA or the wildtype BAG-1M were cotransfected, either 6 μg of the respective plasmid alone (lane2-4), of each 3 μg resp. 6 μg BAG-1MKA and BAG-1Mhsp70mut together (lane 5 resp. 7) or 3 μg resp. 6 μg of BAG-1Mhsp70mut and BAG-1M together (lane 6 resp. 8). Cells were transfected using electroporation, replated and cultured for 24 h in fresh medium either with or without 100 nM dexamethasone. Luciferase activities were corrected by β-galactosidase activities and are presented as percent activity with the firefly-luciferase activity of control vector-transfected cells set as 100%. Results represent mean values±s.e.m. of four independent experiments performed in sextuplicate B/C Representative western blot of either GR- or BAG-protein. Whole cell extracts used for luciferase assays were prepared for SDS-PAGE and immunoblotting. Antibodies were directed against either the C-terminus of BAG or the HA-tag on GR.

FIG. 5:

Model for the inhibitory mechanism of BAG-1M on GR employing its DNA binding and hsp70 interaction domains. Upon activation of the receptor by hormone, BAG-1M and hsp70 are translocated into the nucleus. GR interacts with its binding sites and associated factors open the chromatin structure. This allows BAG-1M to bind to DNA, thereby inhibiting the further functions of GR in the process of transcriptional activation.

The examples illustrate the invention.

FIG. 6:

Amino acid sequence of human BAG1; Genbank Accession No. Q99933

FIG. 7:

Amino acid sequence of human GRα; Genbank Accession No.: AAB64353

FIG. 8:

Amino acid sequence of human GRβ; Genbank Accession No.: AAB64354

### EXAMPLE 1

### Deletion of the N-Terminal DNA Binding Domain of BAG-1 Abolishes its Inhibitory Function on GR, While Deletion of the E₂X₄ Motif Domain Does Not

BAG-1S, the short isoform of BAG-1, is unable to inhibit the transcriptional activity of GR (Schneikert et al., 1999). The N-terminal amino acid stretch missing in BAG-1S as compared to BAG-1M contains a serine- and threonine-rich E₂ X₄ repeat domain and a recently described DNA binding domain (Table 1 and (Zeiner et al., 1999)). To begin to understand which features in the N-terminus are required for inhibition of GR, two deletion mutants were created, either missing the E₂X₄ domain (BAG-1M Δ11-67, Table 1) or the putative DNA binding domain (BAG-1M ΔN10, FIG. 1). To this effect, a series of BAG-1 mutants was generated by PCR and cloned into the mammalian expression plasmid pRK5mcs; most of the mutants were cloned also into pcDNA4TO (InVitrogen), which allows inducible expression in cells containing the Tet-repressor. The plasmid pRK5mcs was derived from pRK5SV40PUR (Spengler et al., 1993) by cutting with the restriction endonucleases EcoRI and HindIII and inserting an annealed linker oligonucleotide with the sequences 5′-AATTCTCGAGATATCGGGCCCGGATCCGCGGCCGCTCGCGA-3′ and 5′AGCTTCGCGAGCGGCCGCGGATCCGGGCCCGATATCTCGAG-3′ for the opposite strand. The wild-type and mutant sequences of BAG-1 were amplified by PCR from the clone (Höhfeld and Jentsch, 1997) using the oligonucleotide 5′ TCC TCT AGA TCA CTC GGC CAG GGC AAA GTT TG 3′ (for cloning into pcDNA4TO) or 5′ TCC GGA TCC CTC GGC CAG GGC AAA GTT TG 3′ (for cloning into pRK5mcs) as downstream primers and one of the following oligonucleotides as upstream primers:

| BAG-1 form | Oligonucleotide sequence 5′ to 3′ |
|---|---|
| wt BAG-1M | TCG GAA TTC ATG AAG AAG AAA ACC CG |
| Δ N10 | CCA GAA TTC ATG CGG AGC GAG GAG TTG A |
| Δ 11-67 | TCC GAA TTC ATG AAA AAG AAG ACT CGC CGG |
| | CGG AGT ACA ATG GCG GCA GCT GGG CTC |
| Wt BAG-1S | TCC GAA TTC ATG GCG GCA GCT GGG CTC |
| Δ 9-67 | TCC GAA TTC ATG AAA AAG AAG ACT CGC CGG |
| | CGG ATG GCG GCA GCT GGG CTC |
| KA | TCC GAA TTC ATG GCT GCC GCA ACC CGG CGC |
| | TCG ACC |
| Δ T₅ | TCG GAA TTC ATG AAG AAG AAA CGG CGC CGC |
| | TCG ACC C |
| +A₅ | TCG GAA TTC ATG AAG AAG AAA GCT AGC CGG |
| | CGC CGC TCG A |
| +2A₅ | TCG GAA TTC ATG AAG AAG AAA GCT GCA ACC |
| | CGG CGC CGC TCG A |

The PCR products were cut with the restriction endouncleases EcoRI and BamHI for cloning into pRK5mcs and cut with EcoRI and XbaI for cloning into pcDNA4TO and gel-purified (Qiaquick, Gel-extraction kit, Qiagen Corp.). Most expression plasmids were created with and without a FLAG tag. The FLAG-tag was put to the N-terminus, because a C-terminal FLAG turned out to be unstable. For all FLAG constructs, the same oligonucleotides were used as listed above except that the sequence in front of the first ATG was replaced by the sequence 5′ TCC GAA TTC ATG GAC TAC AAG GAC GAC GAT GAC AAG 3′. For expression in bacteria the vector pProExHTa (Life Technologies) was chosen. The downstream primer contained the sequence: 5′ TCT GTA TCA GGC TGA AAA TCT TCT CTC 3′, the NcoI and the XbaI site was used for cloning and, therefore, the upstream primers for PCR amplification contained the sequences depicted in the following ′ in front of the first ATG.

These mutants were analysed in transient transfection assays in two cell lines, COS-7 cells and the neuroblastoma cell line SK-N-MC. Cell culture and transfiction were carried out as follows: Human neuroblastoma SK-N-MC cells (ATCC # HTB-10) and COS-7 cells lines were cultured in DMEM supplemented with 10% fetal calf serum (FCS), 36 mg/l sodium pyruvate, 100 units/ml penicillin, 100 μg/ml streptomycin sulfate, 0.25 μg/ml amphothericin (all from Life Technologies, Inc.) and 4.5 g/l glucose at 37° C. and 10% CO₂.

Two days before transfection, cells were seeded into medium containing 10% charcoal-stripped, steroid-free FCS. Dextran T-70 (Pharmacia, Uppsala, Sweden) was used for charcoal-stripping of FCS (Damm, 1994).

Cells were harvested at about 70-90% confluency and about 0.5 to 1×10⁷ cells were resuspended in 400 μl of electroporation buffer (50 mM K₂HPO₄, 20 mM KAc, pH 7.35). 3.5 μg steroid-responsive firefly luciferase reporter plasmid MTV-Luc (Hollenberg and Evans, 1988), 4 μg pRK7GR that expresses human GR (Hollenberg et al., 1985) from the CMV-promoter of the vector pRK7 (Spengler et al., 1993), 6 μg of either one of the BAG-1 expression plasmids (Tables 1 and 2) or the corresponding empty expression vector and, as internal control plasmids, either 3.5 μg simian virus 40 (SV40) promoter-driven β-galactosidase expression vector pCH110 (Pharmacia LKB, Freiburg, Germany) or 1 μg of SV40-driven renilla luciferase driven expression vector (Promega) were added and transfection was performed using an electroporation system (Biotechnologies & Experimental Research, San Diego, Calif.)—after determination of the optimal electrical field strength (Chu et al., 1987). Electroporated cells were replated and cultured for 24 hours in fresh medium (containing 10% steroid-free FCS), supplemented with 100 nM dexamethasone (Sigma-Aldrich) or the solvent of dexamethasone (i.e. ethanol).

Cells were expressed with a reporter plasmid carrying the luciferase gene driven by the GR-sensitive mouse mammary tumor virus (MMTV) promoter, a renilla luciferase reference plasmid and either an empty expression vector or a vector expressing one of the BAG-1M mutants. The firefly luciferase and β-galactosidase assays were as described before (Herr et al., 2000). Either cells were scraped in 200 μl of lysis buffer (0.1 M KHPO₄, pH 7.8, 1 mM DTT) and cytosolic extracts were made by three freeze and thaw cycles and subsequent centrifugation. 50 μl of each supernatant (corresponding to ˜1-2×10⁵ cells) were transferred to a 96 well plate. 150 μl of 33 mM KHPO₄, pH 7.8, 1.7 mM ATP, 3.3 mM MgCl₂, 13 mM Luciferin (Roche Biochemicals, Mannheim, Germany) was added to each sample by the injector of an automatic luminometer (Luminat LB 96, Wallac GmbH, Freiburg, Germany) and light emission was measured for 10 seconds. To correct for variations in transfection efficiencies, values of the luciferase assay were normalized using β-galactosidase activities that were measured as follows: 50 μl of cell extract was added to 100 μl galactosidase buffer (60 mM Na₂HPO₄, 40 mM NaH₂PO₄, 10 mM KCl, 1 mM MgCl₂, 50 mM β-mercaptoethanol) on a 96 well plate. 20 μl of 2 mg/ml ONPG was added and the reaction was incubated at 37° C. After 10-30 minutes, absorption was measured at 405 nm in a multiphotometer (Dynatech MR5000).

Or, when using the renilla luciferase, expression plasmid in combination with the firefly reporter plasmid, cell extracts were scraped in 200 μl of a lysis buffer provided and prepared according to the manufacturers recommendation (Promega Inc.) and firefly and renilla luciferase activities were measured on a 96-well plate in 100 μl cell extract in the automatic luminometer.

BAG-1M clearly inhibited GR-dependent reporter gene transcription, as expected (FIG. 1A). Surprisingly, however, deletion of the E₂X₄ 1A) had no influence on the ability of bag-1 to inhibit the transcriptional activity of GR (FIG. 2A). On the other hand, deletion of the N-terminal 10 amino acids completely abolished the effect of BAG-1 on GR. BAG proteins without the N-terminal FLAG peptides gave the same results. Also, the same pattern of activity of the BAG-1 mutants was observed in COS-7 cells and HeLa-cells. Since co-expression of various plasmids can produce misleading results in case of expression interference (Hofman et al., 2000), the relative amounts of GR and of BAG-1 were rechecked. The protein levels of GR were similar in all the experiments (FIG. 1B). Similarly, the levels of the expressed BAG-1 proteins were comparable throughout our experiments (FIG. 1C). Therefore, the domain recently put forward as DNA binding domain of BAG-1 (Zeiner et al., 1999) is necessary for the inhibitory effect of BAG-1 on GR.

### EXAMPLE 2

### Spacing of the Lysine and Arginine Stretch is Not Important for DNA Binding of BAG-1

To characterise the DNA binding domain of BAG-1 in more detail, a series of additional mutants were created (FIG. 3); all proteins (FIGS. 1 and 3) derived from BAG-1 mutants and isoforms in table 1 and 2 were expressed in bacteria and purified (FIG. 2A/B). As a reference, lysines 2, 3 and 4 were mutated to alanines (BAG-1M KA), which has been described to abolish DNA binding of BAG-1. To confine the DNA binding domain essentially to the positively charged amino acids lysine and arginine, amino acids 9 to 67 (Δ9-67) were deleted. Moreover, the spacing between lysines 2, 3, 4 and arginines 6, 7, 8 was changed by either deleting threonine 5 (BAG-1M −T₅) or inserting one (BAG-1M +A₅) or two alanines-(BAG-1M +2A₅). After expression in bacteria, proteins were purified using Ni-NTA agarose (FIG. 2A/B;a-lanes) and the histidine tails were cleaved with tobacco etch virus protease (FIG. 2A/B;b-lanes). To this effect, Histidine-tagged BAG-1 encoding plasmids were grown in pBL3Lys-bacteria (Life Technologies). Lysis and purification was performed using Ni-NTA agarose according to the manufacturer's recommendations (Qiagen). The histidine tag was removed by cleavage with TEV protease for 6 h at 30° C. (Life Technologies). Then, cleaved proteins were rebound to Ni-NTA agarose columns again to remove traces of uncleaved proteins and purified afterwards with Biospin columns (Bio-Rad) to remove DDT from cleavage-buffer and traces of liquid columns. Protein concentrations were determined using the BCA-Protein-Assay-Kit (Pierce).

The purified and cleaved proteins were used to examine their ability to bind to DNA. The 125 base pair fragment of a Hind III cleavage of DNA from bacteriophage Δ was chosen as template. Gel shift assays (FIG. 4C) revealed that mutation of lysines 2, 3 and 4 to alanines abolished DNA binding, consistent with a recent report (Zeiner et al., 1999). Experimentally, DNA binding of BAG-1 was essentially performed as described (Zeiner, Niyaz, et al. 1999). Briefly, 1 μg or 2 μg of purified and TEV-cleaved BAG-protein (isoforms or mutant) were incubated with 0.2 ng of 32P-end-labeled 125 bp λ/HindIII DNA fragment in binding buffer (Zeiner, Niyaz, et al. 1999) for 30 min. at RT. Protein DNA complexes were resolved on native 5% acrylamide gels in TBE buffer.

However, deletion of the E₂X₄ domain (BAG-1M Δ11-67) had no influence on DNA binding. Even additional deletion of two N-terminal amino acids retained DNA binding (BAG-1M Δ9-67). BAG-1S, as expected, did not bind to DNA. Therefore, it appears that the first 8 N-terminal amino acids are sufficient to confer the ability of BAG-1 to bind to DNA. Moreover, spacing between the positively charged amino acids lysines 2, 3, 4 and arginines 6, 7, 8 is not important for DNA binding, because these mutants bind to DNA as efficiently as BAG-1M (FIG. 2C/D). Therefore, BAG-1M apparently contains a short, unusual DNA binding domain.

### EXAMPLE 3

### Mutants that Inhibit DNA Binding of BAG-1 also Abolish its Inhibitory Function on GR

The results shown in FIG. 1 suggest that DNA binding of BAG-1 is necessary for its inhibitory effect on GR function. We set out to either strengthen this correlation or prove that, while this domain per se is necessary, it is not DNA binding, but some other property of this domain that causes the inhibitory effect. Therefore, expression clones of all mutants, with and without FLAG-tag were constructed, and tested in the transient reporter gene assay as described in FIG. 2. BAG-1M Δ9-67, BAG-1M −T₅, BAG-1M +A₅ and BAG-1M +2A₅ all were able to inhibit GR-dependent transcription (FIG. 3A). In contrast, BAG-1S and BAG-1M KA lost the inhibitory effect on GR. Again, the protein levels of GR were comparable throughout the experiments (FIG. 3B), as were the levels of the different BAG-1 mutants (FIG. 3C). The results with BAG-1 mutants without a FLAG tag showed the same pattern. Also, similar data were obtained in HeLa cells.

Therefore, the data in FIGS. 1, 2 and 3 clearly demonstrate that all mutants of BAG-1M that are able to bind to DNA inhibit the transcriptional activity of GR, while those that are unable to bind to DNA have no influence on GR activity.

### EXAMPLE 4

### The DNA Binding and the hsp70 Interaction Domain of BAG-1 Need to be Present in cis to Inhibit GR Function

Besides the N-terminal domain, deletion of the C-terminal 70 amino acids also abolishes the effect of BAG-1 on GR (Schneikert et al., 2000). Since these amino acids contain the interaction domain with hsp70, it has been proposed that interaction with hsp70 is necessary for the function of BAG-1. This raises the question whether the domains responsible for interaction with hsp70 and for binding to DNA are required to be present in cis. Therefore, a point mutation of BAG-1 that abolishes interaction with hsp70 (R237A BAG-1M (Sondermann et al., 2001) and data not shown) was first created.

In the above-recited transient reporter gene assay, this mutant abolishes the inhibition of GR activity by BAG-1 (FIG. 4A, lane 4). This proves that the inability to interact with hsp70 rather than some other, concomitant consequence is the correct explanation for the effect of C-terminal deletions of BAG-1. To test whether a BAG-1 protein that is unable to interact with hsp70, but has an intact DNA binding domain, can rescue the inhibitory function of a DNA binding mutant bearing an intact hsp70 interaction domain, a DNA binding mutant was concomitantly expressed with an hsp70 interaction mutant in the reporter assay. Although these proteins are expressed to the same or even higher level compared to wt BAG-1 (FIG. 4B), no inhibition of GR-dependent reporter gene transcription was detected (FIG. 4A, lanes 5+6). The levels of GR were the same throughout the experimental conditions (FIG. 4C). It is concluded that the N-terminal domain and the hsp70 interaction domain of BAG-1 need to be present at the same time and on the same molecule.

### REFERENCE LIST

Ballinger, C. A., Connell, P., Wu, Y., Hu, Z., Thompson, L. J., Yin, L. Y., and Patterson, C. (1999). Identification of CHIP, a novel tetratricopeptide repeat-containing protein that interacts with heat shock proteins and negatively regulates chaperone functions. Mol Cell Biol 19, 4535-4545.
Beato, M.; Chalepakis, G.; Schauer, M.; Slater, E. P. DNA regulatory elements for steroid hormones. (1989). J. Steroid Biochem. 32, 737-747
Bimston, D., Song, J., Winchester, D., Takayama, S., Reed, J. C., and Morimoto, R. I. (1998). BAG-1, a negative regulator of Hsp70 chaperone activity, uncouples nucleotide hydrolysis from substrate release. EMBO J. 17, 6871-6878.
Bresnick, E. H., Dalman, F. C., Sanchez, E. R., and Pratt, W. B. (1989). Evidence that the 90-kDa heat shock protein is necessary for the steroid binding conformation of the L cell glucocorticoid receptor. J. Biol. Chem. 264, 4992-4997.
Briknarova, K., Takayama, S., Brive, L., Havert, M. L., Knee, D. A., Velasco, J., Homma, S., Cabezas, E., Stuart, J., Hoyt, D. W., Satterthwait, A. C., Llinas, M., Reed, J. C., and Ely, K. R. (2001). Structural analysis of BAG1 cochaperone and its interactions with Hsc70 heat shock protein. Nat. Struct. Biol. 8, 349-352.
Brody, E N and Gold, L (2000) Aptamers as therapeutic and diagnostic agents. J Biotechnol 74, 5-13.
Bronstein, I, Fortin, J, Stanley, P E, Stewart, G S, Kricka, L J (1994) Chemiluminescent and bioluminescent reporter gene assays. Anal Biochem 219, 169-181.
Buchner, J. (1999). Hsp90 & Co.—a holding for folding. Trends Biochem Sci 24, 136-141.
Chen, S, Wang, J, Yu, G, Liu, W, Pearce, D (1997) Androgen and glucocorticoid receptor heterodimer formation. A possible mechanism for mutual inhibition of transcriptional activity. J Biol Chem 272, 14087-14092.
Chu, G., Hayakawa, H., and Berg, P. (1987). Electroporation for the efficient transfection of mammalian cells with DNA. Nucleic Acids Res 15, 1311-1326.
Damm, K. (1994). Gene transfection studies using recombinant steroid receptors. In Methods in Neurosciences: Neurobiology of Steroids. E. R. De Kloet and W. Sutanto, eds. (San Diego: Academic Press), pp. 265-276.
Dittmar, K. D., Banach, M., Galigniana, M. D., and Pratt, W. B. (1998). The role of DnaJ-like proteins in glucocorticoid receptor.hsp90 heterocomplex assembly by the reconstituted hsp90.p60.hsp70 foldosome complex. J. Biol. Chem. 273, 7358-7366.
Dittmar, K. D., Demady, D. R., Stancato, L. F., Krishna, P., and Pratt, W. B. (1997). Folding of the glucocorticoid receptor by the heat shock protein (hsp) 90-based chaperone machinery. The role of p23 is to stabilize receptor.hsp90 heterocomplexes formed by hsp90.p60.hsp70. J. Biol. Chem. 272, 21213-21220.
Dittmar, K. D., Hutchison, K. A., Owens-Grillo, J. K., and Pratt, W. B. (1996). Reconstitution of the steroid receptor.hsp90 heterocomplex assembly system of rabbit reticulocyte lysate. J. Biol. Chem. 271, 12833-12839.
Dolle, R E (2000) Comprehensive survey of combinatorial library synthesis: 1999. J Comb Chem 2, 383-433.
Drouin, J, Sun, Y L, Chamberland, M, Gauthier, Y, De Lean, A, Nemer, M, Schmidt, T J (1993) Novel glucocorticoid receptor complex with DNA element of the hormone-repressed POMC gene. EMBO J. 12, 145-156.
Fischer, P. M., Zhelev, N. Z., Wang, S., Melville, J. E., Fahraeus, R., and Lane, D. P. (2000). Structure-activity relationship of truncated and substituted analogues of the intracellular delivery vector Penetratin. J. Pept. Res. 55,163-172.
Freedman, L. P. (1999). Increasing the complexity of coactivation in nuclear receptor signaling. Cell 97, 5-8.
Freeman, B. C., Felts, S. J., Toft, D. O., and Yamamoto, K. R. (2000). The p23 molecular chaperones act at a late step in intracellular receptor action to differentially affect ligand efficacies. Genes Dev 14, 422-434.
Freeman, B. C., Myers, M. P., Schumacher, R., and Morimoto, R. I. (1995). Identification of a regulatory motif in Hsp70 that affects ATPase activity, substrate binding and interaction with HDJ-1. EMBO J. 14, 2281-2292.
Froesch, B. A., Takayama, S., and Reed, J. C. (1998). BAG-1L protein enhances androgen receptor function. J Biol Chem 273, 11660-11666.
Gast, A, Neuschmid-Kaspar, F, Klocker, H, Cato, A C (1995) A single amino acid exchange abolishes dimerization of the androgen receptor and causes Reifenstein syndrome. Mol Cell Endocrinol 111, 93-98.
Gebauer, M., Zeiner, M., and Gehring, U. (1998). Interference between proteins Hap46 and Hop/p60, which bind to different domains of the molecular chaperone hsp70/hsc70. Mol. Cell Biol. 18, 6238-6244.
Guzey, M., Takayama, S., and Reed, J. C. (2000). BAG1L enhances trans-activation function of the vitamin D receptor. J. Biol. Chem.
Herr, A., Wochnik, G. M., Rosenhagen, M. C., Holsboer, F., and Rein, T. (2000). Rifampicin is not an activator of the glucocorticoid receptor. Mol. Pharmacol. 57, 732-737.
Hofman, K., Swinnen, J. V., Claessens, F., Verhoeven, G., and Heyns, W. (2000). Apparent coactivation due to interference of expression constructs with nuclear receptor expression. Mol. Cell Endocrinol. 168, 21-29.
Hollenberg, S. M. and Evans, R. M. (1988). Multiple and cooperative trans-activation domains of the human glucocorticoid receptor. Cell 55, 899-906.
Hollenberg, S. M., Weinberger, C., Ong, E. S., Cerelli, G., Oro, A., Lebo, R., Thompson, E. B., Rosenfeld, M. G., and Evans, R. M. (1985). Primary structure and expression of a functional human glucocorticoid receptor cDNA. Nature 318, 635-641.
Höhfeld, J. and Jentsch, S. (1997). GrpE-like regulation of the hsc70 chaperone by the anti-apoptotic protein BAG-1 [published erratum appears in EMBO J. 1998 Feb. 2; 17 (3):847]. EMBO J. 16, 6209-6216.
Höhfeld, J., Minami, Y., and Hartl, F. U. (1995). Hip, a novel cochaperone involved in the eukaryotic Hsc70/Hsp40 reaction cycle. Cell 83, 589-598.
Hoppe-Seyler, F Butz, K (2000) Peptide aptamers: powerful new tools for molecular medicine. J Mol Med 78, 426-430.
Irving, M B, Pan, O, Scott, J K (2001) Random-peptide libraries and antigen-fragment libraries for epitope mapping and the development of vaccines and diagnostics. Curr Opin Chem Biol 5, 314-324.
Jayasena, S D (1999) Aptamers: an emerging class of molecules that rival antibodies in diagnostics. Clin Chem 45, 1628-1650.
Kanelakis, K. C., Murphy, P. J., Galigniana, M. D., Morishima, Y., Takayama, S., Reed, J. C., Toft, D. O., and Pratt, W. B. (2000). hsp70 interacting protein hip does not affect glucocorticoid receptor folding by the hsp90-based chaperone machinery except To oppose the effect of BAG-1 [In Process Citation]. Biochemistry 39, 14314-14321.
Kay, B K, Kasanov, J, Yamabhai, M (2001) Screening phage-displayed combinatorial peptide libraries. Methods 24, 240-246.
Knee, D. A., Froesch, B. A., Nuber, U., Takayama, S., and Reed, J. C. (2001). Structure-function analysis of bag1 proteins. effects on androgen receptor transcriptional activity. J. Biol. Chem. 276, 12718-12724.
Kullmann, M., Schneikert, J., Moll, J., Heck, S., Zeiner, M., Gehring, U., and Cato, A. C. (1998). RAP46 is a negative regulator of glucocorticoid receptor action and hormone-induced apoptosis. J. Biol. Chem. 273, 14620-14625.
Lewis, J C, Feltus, A, Ensor, C M, Ramanathan, S, Daunert, S (1998) Applications of reporter genes. Anal Chem 70, 579A-585A.
Lindgren, M., Hallbrink, M., Prochiantz, A., and Langel, U. (2000). Cell-penetrating peptides. Trends. Pharmacol. Sci. 21, 99-103.
Liu, J. and DeFranco, D. B. (1999). Chromatin recycling of glucocorticoid receptors: implications for multiple roles of heat shock protein 90. Mol. Endocrinol 13, 355-365.
Liu, R., Takayama, S., Zheng, Y., Froesch, B., Chen, G. Q., Zhang, X., Reed, J. C., and Zhang, X. K. (1998). Interaction of BAG-1 with retinoic acid receptor and its inhibition of retinoic acid-induced apoptosis in cancer cells. J. Biol. Chem. 273, 16985-16992.
Liu, W, Wang, J, Sauter, N K, Pearce, D 1995 Steroid receptor heterodimerization demonstrated in vitro and in vivo. Proc Natl Acad Sci USA 92, 12480-12484.
Mangelsdorf, D J, Thummel, C, Beato, M, Herrlich, P, Schutz, G, Umesono, K, Blumberg, B, Kastner, P, Mark, M, Chambon, P (1995). The nuclear receptor superfamily: the second decade. Cell 83, 835-839.
McNally, J. G., Muller, W. G., Walker, D., Wolford, R., and Hager, G. L. (2000). The glucocorticoid receptor: rapid exchange with regulatory sites in living cells. Science 287, 1262-1265.
Michels, A. A., Kanon, B., Bensaude, O., and Kampinga, H. H. (1999). Heat shock protein (Hsp) 40 mutants inhibit Hsp70 in mammalian cells. J. Biol. Chem. 274, 36757-36763.
Michels, A. A., Kanon, B., Konings, A. W., Ohtsuka, K., Bensaude, O., and Kampinga, H. H. (1997). Hsp70 and Hsp40 chaperone activities in the cytoplasm and the nucleus of mammalian cells. J. Biol. Chem. 272, 33283-33289.
Mittler, G, Kremmer, E, Timmers, H T, Meisterernst, M (2001) Novel critical role of a human Mediator complex for basal RNA polymerase 11 transcription. EMBO Rep 2, 808-813.
Naylor, L H 1999 Reporter gene technology: the future looks bright. Biochem Pharmacol 58, 749-757.
Niyaz, Y., Zeiner, M., and Gehring, U. (2001). Transcriptional activation by the human Hsp70-associating protein Hap50. J. Cell Sci. 114, 1839-1845.
Nollen, E. A., Brunsting, J. F., Song, J., Kampinga, H. H., and Morimoto, R. I. (2000a). Bag1 functions In vivo as a negative regulator of hsp70 chaperone activity. Mol Cell Biol 20, 1083-1088.
Nollen, E. A., Kabakov, A. E., Brunsting, J. F., Kanon, B., Hohfeld, J., and Kampinga, H. H. (2000b). Modulation of in vivo HSP70 chaperone activity by Hip and BAG-1. J. Biol; Chem.
Ohashi, Y, Brickman, J M, Furman, E, Middleton, B, Carey, M (1994) Modulating the potency of an activator in a yeast in vitro transcription system. Mol Cell Biol 14, 2731-2739.
Osborne, S E, Matsumura, I, Ellington, A D (1997) Aptamers as therapeutic and diagnostic reagents: problems and prospects. Curr Opin Chem Biol 1, 5-9.
Ou, X M, Storring, J M, Kushwaha, N, Albert, P R (2001). Heterodimerization of mineralocorticoid and glucocorticoid receptors at a novel negative response element of the 5-HT1A receptor gene. J Biol Chem 276, 14299-14307.
Packham, G., Brimmell, M., and Cleveland, J. L. (1997). Mammalian cells express two differently localized BAG-1 isoforms generated by alternative translation initiation. Biochem. J. 328, 807-813.
Pichon, B and Christophe, D (1998) An in vitro transcription system for the study of thyroid-specific transcription. Anal Biochem 261, 233-235.
Pratt, W. B. and Dittmar, K. D. (1998). Studies with purified chaperones advance the understanding of the mechanism of glucocorticoid receptor-hsp90 heterocomplex assembly. Trends Endocrinol Metabol 9, 244-252.
Pratt, W. B. and Toft, D. O. (1997). Steroid receptor interactions with heat shock protein and immunophilin chaperones. Endocr Rev 18, 306-360.
Savory, J G, Prefontaine, G G, Lamprecht, C, Liao, M, Walther, R F, Lefebvre, Y A, Hache, R J (2001) Glucocorticoid Receptor Homodimers and Glucocorticoid-Mineralocorticoid Receptor Heterodimers Form in the Cytoplasm through Alternative Dimerization Interfaces. Mol Cell Biol 21, 781-793.
Schenborn, E Groskreutz, D (1999) Reporter gene vectors and assays. Mol Biotechnol 13, 29-44.
Scheufler, C., Brinker, A., Bourenkov, G., Pegoraro, S., Moroder, L., Bartunik, H., Hartl, F. U., and Moarefi, I. (2000). Structure of TPR domain-peptide complexes: critical elements in the assembly of the Hsp70-Hsp90 multichaperone machine. Cell 101, 199-210.
Schneikert, J., Hübner, S., Langer, G., Petri, T., J\ddot{aa}ttelä, M., Reed, J., and Cato, A. C. (2000). Hsp70-RAP46 interaction in downregulation of DNA binding by glucocorticoid receptor. EMBO J. 19, 6508-6516.
Schneikert, J., Hübner, S., Martin, E., and Cato, A. C. (1999). A nuclear action of the eukaryotic cochaperone RAP46 in downregulation of glucocorticoid receptor activity. J Cell Biol 146, 929-940.
Service, R. F. (2000). Biochemistry. Chemical tags speed delivery into cells. Science 288, 28-29.
Silverman, L, Campbell, R, Broach, J R (1998) New assay technologies for high-throughput screening. Curr Opin Chem Biol 2, 397-403.
Sondermann, H., Scheufler, C., Schneider, C., Höhfeld, J., Hartl, F. U., and Moarefi, I. (2001). Structure of a Bag/Hsc70 Complex: Convergent Functional Evolution of Hsp70 Nucleotide Exchange Factors. Science 291, 1553-1557.
Song, J., Takeda, M., and Morimoto, R. I. (2001). Bag1-Hsp70 mediates a physiological stress signalling pathway that regulates Raf-1/ERK and cell growth. Nat. Cell Biol. 3, 276-282.
Spengler, D., Waeber, C., Pantaloni, C., Holsboer, F., Bockaert, J., Seeburg, P. H., and Journot, L. (1993). Differential signal transduction by five splice variants of the PACAP receptor. Nature 365,170-175.
Trapp, T Holsboer, F (1996) Heterodimerization between mineralocorticoid and glucocorticoid receptors increases the functional diversity of corticosteroid action. Trends Pharmacol Sci 17, 145-149.
Takayama, S., Krajewski, S., Krajewska, M., Kitada, S., Zapata, J. M., Kochel, K., Knee, D., Scudiero, D., Tudor, G., Miller, G. J., Miyashita, T., Yamada, M., and Reed, J. C. (1998). Expression and location of Hsp70/Hsc-binding anti-apoptotic protein BAG-1 and its variants in normal tissues and tumor cell lines. Cancer Res 58, 3116-3131.
Takayama, S., Sato, T., Krajewski, S., Kochel, K., Irie, S., Millan, J. A., and Reed, J. C. (1995). Cloning and functional analysis of BAG-1: a novel Bcl-2-binding protein with anti-cell death activity. Cell 80, 279-284.
Thress, K., Song, J., Morimoto, R. I., and Kornbluth, S. (2001). Reversible inhibition of Hsp70 chaperone function by Scythe and Reaper. EMBO J. 20, 1033-1041.
Toft, D. O. (1998). Recent advances in the study of hsp90 structure and mechanism of action. TEM 9, 238-243.
Turner, B. C., Krajewski, S., Krajewska, M., Takayama, S., Gumbs, A. A., Carter, D., Rebbeck, T. R., Haffty, B. G., and Reed, J. C. (2001). BAG-1: a novel biomarker predicting long-term survival in early-stage breast cancer. J. Clin. Oncol. 19, 992-1000.
Witcher, M., Yang, X., Pater, A., and Tang, S. C. (2001). BAG-1 p50 Isoform Interacts with the Vitamin D Receptor and Its Cellular Overexpression Inhibits the Vitamin D Pathway. Exp. Cell Res. 265,167-173.
Yang, X., Chernenko, G., Hao, Y., Ding, Z., Pater, M. M., Pater, A., and Tang, S. C. (1998). Human BAG-1/RAP46 protein is generated as four isoforms by alternative translation initiation and overexpressed in cancer cells. Oncogene 17, 981-989.
Zeiner, M., Gebauer, M., and Gehring, U. (1997). Mammalian protein RAP46: an interaction partner and modulator of 70 kDa heat shock proteins. EMBO J. 16, 5483-5490.
Zeiner, M. and Gehring, U. (1995). A protein that interacts with members of the nuclear hormone receptor family: identification and cDNA cloning. Proc. Natl. Acad. Sci. U.S.A. 92, 11465-11469.
Zeiner, M., Niyaz, Y., and Gehring, U. (1999). The hsp70-associating protein Hap46 binds to DNA and stimulates transcription. Proc Natl Acad Sci USA 96, 10194-10199.

1. A method of identifying a compound that inhibits or reduces bag-1 mediated downregulation of glucocorticoid-receptor (GR) transactivation said method comprising the steps of
(a) contacting a test compound or a plurality of test compounds with
(aa) a (poly)peptide comprising the motif X-Lys-Lys-Lys-Y-Arg-Arg-Arg wherein X and Y represent 0, 1, 2, 3, 4, 5 or 6 amino acids and wherein said amino acids allow binding of the motif to double-stranded DNA; and
(ab) a double-stranded DNA under conditions that allow binding of said (poly)peptide to said DNA in the absence of said test compound or said plurality of test compounds; and
(b) assessing whether binding of said (poly)peptide to said DNA occurs in the presence of said test compound or said plurality of test compounds wherein inhibition or reduction of binding is indicative of the test compound(s) being suitable to inhibit or reduce bag-1 mediated downregulation of GR transactivation.

2. The method of claim 1 wherein said motif recited in (aa) is located at the N-terminus of said (poly)peptide.

3. The method of claim 1 wherein said DNA carries a readout-system that is activated by the binding of said (poly)peptide to said DNA.

4. A method of identifying a compound that inhibits or reduces bag-1 mediated downregulation of glucocorticoid-receptor transactivation said method comprising the steps of
(a) contacting a test compound or a plurality of test compounds with
(aa) a (poly)peptide comprising the motif X-Lys-Lys-Lys-Y-Arg-Arg-Arg preferably at its N-terminus wherein X and Y represent 0, 1, 2, 3, 4, 5 or 6 amino acids; and
a domain that is the hsp70 binding domain of bag-1 or functionally equivalent thereto;
(ab) a polypeptide representing the GR or a functionally equivalent molecule; and
(ac) a double-stranded DNA molecule comprising a binding site for the GR under conditions that allow the formation of a functional (poly)peptide complex consisting of said (poly)peptides recited in (aa) to (ab) and binding of said polypeptide recited in (ab) with said double-stranded DNA molecule in the absence of said test compound or said plurality of test compounds; and
(ba) assessing whether said polypeptide recited in (ab) binds to said double-stranded DNA wherein an increase of binding is indicative of the test compound(s) being suitable to inhibit or reduce bag-1 mediated downregulation of GR transactivation; or
(bb) assessing whether said complex formation and/or DNA-binding recited in (ac) results in a transactivation of GR wherein an increased level of transactivation is indicative of the test compound(s) being suitable to inhibit or reduce bag-1 mediated downregulation of GR transactivation.

5. The method of claim 4 wherein said test compound or plurality of test compounds, said (poly)peptides recited in steps (aa) and (ab) and said double-stranded DNA molecule are further contacted with
(ad) a (poly)peptide comprising the bag-1 binding domain of hsp70 or a functionally equivalent domain and the GR binding domain of hsp70 or a functionally equivalent domain.

6. The method of claim 4 or 5 wherein the amino acids X and Y comprised in the (poly)peptide recited in (aa) allow binding of the motif to a double-stranded DNA.

7. The method of claim 4 or 5 wherein said test compound or plurality of test compounds is/are further contacted with a double-stranded DNA molecule that does not comprise a binding site for GR.

8. The method of claim 4 wherein said double-stranded DNA molecule recited in (ac) further carries a readout-system that is activated upon binding of said GR to said DNA.

9. The method of claim 3 or 8 wherein said readout-system comprises a reporter gene.

10. The method of claim 9 wherein said reporter gene is selected from the group consisting of firefly luciferase, renilla luciferase, β-galactosidase, GFP or another fluorescent protein, CAT (chloramphenicolacetyltransferase), alkaline phosphotase including SEAP (secreted alkaline phosphatase), TAT (tyrosyl aminotransferase) and peroxidase.

11. The method of claim 9 wherein said reporter gene is a gene encoding a transmembrane protein.

12. The method of claim 11 wherein said transmembrane protein is a receptor polypeptide.

13. The method of any one of claims 1 to 5 wherein said test compound(s) is/are selected from the group consisting of small molecules, peptides, aptamers and antibodies or fragments or derivatives thereof.

14. The method of claim 13 wherein said small molecules are small organic molecules.

15. The method of claim 13 wherein said peptides are derived from an at least partially randomized peptide library.

16. The method of claim 13 wherein said antibodies are monoclonal antibodies.

17. The method of any one of claims 1 to 5 wherein, if a plurality of test compounds is tested,
(a) different members of said plurality of test compounds are tested in different reaction vessels wherein those reaction vessels that do not contain test compounds indicative of being suitable to inhibit or reduce bag-1 mediated downregulation of GR transactivation are not further considered;
(b) members contained in reaction vessels that test positive with regard to inhibition or reduction of bag-1 mediated downregulation of GR transactivation are redistributed into different reaction vessel and tested again; and optionally
(c) step (b) is repeated until a single compound is identified that is suitable to inhibit or reduce bag-1 mediated downregulation of GR transactivation.

18. The method of any of claims 1 to 5 wherein the assessment is effected in an in vitro transcription/translation system or using bacteriophage based systems using the T7, T3 or Sp6 promoter.

19. The method of any of claims 1 to 5 wherein the assessment is effected in an eukaryotic cell or tissue or an extract thereof.

20. The method of any one of claims 1 to 5 wherein X is Met.

21. The method of any one of claims 1 to 5 wherein Y is Thr.

22. The method of any one of claims 1 to 5 wherein Y is 0.

23. The method of any one of claims 1 to 5 wherein Y is Ala-Thr.

24. The method of any one of claims 1 to 5 wherein Y is Ala-Ala-Thr.

25. The method of any one of claims 1-5 wherein said (poly)peptide comprising the motif X-Lys-Lys-Lys-Y-Arg-Arg-Arg is bag-1.

26. The method of claim 5 wherein said (poly)peptide recited in step (ad) is hsp70.

27. The method of claim 1 or 5 further comprising refining the identified compound, comprising the steps of:
(i) identification of the binding site of said compound binding to said motif and optionally of the binding site of said motif binding to said compound;
(ii) molecular modeling of the binding site of the compound and optionally of the motif; and
(iii) modification of the compound to improve its binding specificity for the motif.

28. The method of claim 1 or 5 further comprising refining the identified compound, comprising:
(a) modeling said compound by peptidomimetics; and
(b) chemically synthesizing the modeled compound.

29. The method of claim 1 or 5, further comprising modifying the identified compound, comprising attaching said compound to a signal peptide.

30. The method of claim 1 or 5, further comprising modifying the identified compound as a lead compound to achieve
(i) modified site of action, spectrum of activity, organ specificity; and/or
(ii) improved potency; and/or
(iii) decreased toxicity (improved therapeutic index); and/or
(iv) decreased side effects; and/or
(v) modified onset of therapeutic action, duration of effect; and/or
(vi) modified pharmakinetic parameters (resorption, distribution, metabolism and excretion); and/or
(vii) modified physico-chemical parameters (solubility; hygroscopicity; color, taste, odor, stability, state); and/or
(viii) improved general specificity, organ/tissue specificity; and/or
(ix) optimized application form and route by
(i) esterification of carboxyl groups; or
(ii) esterification of hydroxol groups with carbon acids; or
(iii) esterification of hydroxol groups to, e.g. phosphates, pyrophosphates or sulfates or hemi succinates; or
(iv) formation of pharmaceutically acceptable salts; or
(v) formation of pharmaceutically acceptable complexes; or
(vi) synthesis of pharmacologically active polymers; or
(vii) introduction of hydrophilic moieties; or
(viii) introduction/exchange of substituents on aromates or side chains, change of substituent pattern; or
(ix) modification by introduction of isoteric or bioisoteric moieties; or
(x) synthesis of homologus compounds; or
(xi) introduction of branched side chains; or
(xii) conversion of alkyl substituents to cyclic analogues; or
(xiii) derivatisation of hydroxyl group to kelates, acetates; or
(xiv) N-acetylation to amides, pheycarbamates; or
(xv) synthesis of Mannich bases; imines; or
(xvi) transformation of ketones or aldehydes to Schiffs bases, oximes, acetates, ketales, enolesters, oxazolidines, thiozolidines;
or combinations thereof.

31. The method of claim 1 or 5, further comprising producing a pharmaceutical composition comprising the step of formulating one or more of the identified compounds with a pharmaceutically acceptable carrier or diluent.

32. (canceled)

33. The method of claim 29, wherein the identified compound has been refined by the method of claim 27 or 28 before said compound is further modified.

34. The method of claim 30, wherein the identified compound has been refined by the method of claim 27 or 28 before said compound is further modified.

35. The method of claim 31, wherein the identified compound has been refined by the method of claim 27 or 28 before said compound.


SEQUENCE LISTING (19 sequences)

SEQ ID NO: 1 - protein, 8 aa, Artificial Sequence
  DNA-binding motif
XKKKYRRR

SEQ ID NO: 2 - DNA, 41 bp, Unknown
  oligonucleotide primer
aattctcgagatatcgggcccggatccgcggccgctcgcga

SEQ ID NO: 3 - DNA, 41 bp, Unknown
  oligonucleotide primer
agcttcgcgagcggccgcggatccgggcccgatatctcgag

SEQ ID NO: 4 - DNA, 32 bp, Unknown
  oligonucleotide primer
tcctctagatcactcggccagggcaaagtttg

SEQ ID NO: 5 - DNA, 29 bp, Unknown
  oligonucleotide primer
tccggatccctcggccagggcaaagtttg

SEQ ID NO: 6 - DNA, 26 bp, Unknown
  oligonucleotide primer
tcggaattcatgaagaagaaaacccg

SEQ ID NO: 7 - DNA, 28 bp, Unknown
  oligonucleotide primer
ccagaattcatgcggagcgaggagttga

SEQ ID NO: 8 - DNA, 57 bp, Unknown
  oligonucleotide primer
tccgaattcatgaaaaagaagactcgccggcggagtacaatggcggcagctgggctc

SEQ ID NO: 9 - DNA, 27 bp, Unknown
  oligonucleotide primer
tccgaattcatggcggcagctgggctc

SEQ ID NO: 10 - DNA, 51 bp, Unknown
  oligonucleotide primer
tccgaattcatgaaaaagaagactcgccggcggatggcggcagctgggctc

SEQ ID NO: 11 - DNA, 36 bp, Unknown
  oligonucleotide primer
tccgaattcatggctgccgcaacccggcgctcgacc

SEQ ID NO: 12 - DNA, 37 bp, Unknown
  oligonucleotide primer
tcggaattcatgaagaagaaacggcgccgctcgaccc

SEQ ID NO: 13 - DNA, 40 bp, Unknown
  oligonucleotide primer
tcggaattcatgaagaagaaagctacccggcgccgctcga

SEQ ID NO: 14 - DNA, 43 bp, Unknown
  oligonucleotide primer
tcggaattcatgaagaagaaagctgcaacccggcgccgctcga

SEQ ID NO: 15 - DNA, 36 bp, Unknown
  oligonucleotide primer
tccgaattcatggactacaaggacgacgatgacaag

SEQ ID NO: 16 - DNA, 27 bp, Unknown
  oligonucleotide primer
tctgtatcaggctgaaaatcttctctc

SEQ ID NO: 17 - protein, 274 aa, Unknown
  peptide that regulates glucocorticoid-receptor transactivation
MKKKTRRRSTRSEELTRSEELTLSEEATWSEEATQSEEATQGEEMNRSQEVTRDEESTRSEEVTREEMAAAGLTVTVTHSNEKHDLHVTSQQGSSEPVVQDLAQVVEEVIGVPQSFQKLIFKGKSLKEMETPLSALGIQDGCRVMLIGKKNSPQEEVELKKLKHLEKSVEKIADQLEELNKELTGIQQGFLPKDLQAEALCKLDRRVKATIEQFMKILEEIDTLILPENFKDSRLKRKGLVKKVQAFLAECDTVEQNICQETERLQSTNFALAE

SEQ ID NO: 18 - protein, 776 aa, Unknown
  peptide that regulates glucocorticoid-receptor transactivation
MDSKESLTPGREENPSSVLAQERGDVMDFYKTLRGGATVKVSASSPSLAVASQSDSKQRRLLVDFPKGSVSNAQQPDLSKAVSLSMGLYMGETETKVMGNDLGFPQQGQISLSSGETDLKLLEESIANLNRSTSVPENPKSSASTAVSAAPTEKEFPKTHSDVSSEQQHLKGQTGTNGGNVKLYTTDQSTFDILQDLEFSSGSPGKETNESPWRSDLLIDENCLLSPLAGEDDSFLLEGNSNEDCKPLILPDTKPKIKDNGDVLSSPSNVTLPQVKTEKEDFIELCTPGVIKQEKLGTVYCQASFPGANIIGNKMSAISVHGVSTSGGQMYHYDMNTASLSQQQDQKPIFNVIPPIPVGSENWNRCQGSGDDNLTSLGTLNFPGRTVFSNGYSSPSMRPDVSSPPSSSSTATTGPPPKLCLVCSDEASGCHYGVLTCGSCKVFFKRAVEGQHNYLCAGRNDCIIDKIRRKNCPACRYRKCLQAGMNLEARKTKKKIKGIQQATTGVSQETSENPGNKTIVPATLPQLTPTLVSLLEVIEPEVLYAGYDSSVPDSTWRIMTTLNMLGGRQVIAAVKWAKAIPGFRNLHLDDQMTLLQYSWMFLMAFALGWRSYRQSSANLLCFAPDLIINEQRMTLPCMYDQCKHMLYVSSELHRLQVSYEEYLCMKTLLLLSSVPKDGLKSQELFDEIRMTYIKELGKAIVKREGNSSQNWQRFYQLTKLLDSMHEVVENLLNYCFQTFLDKTMSIEFPEMLAEIITNQIPKYSNGNIKKLLFHQK

SEQ ID NO: 19 - protein, 741 aa, Unknown
  peptide that regulates glucocorticoid-receptor transactivation
MDSKESLTPGREENPSSVLAQERGDVMDFYKTLRGGATVKVSASSPSLAVASQSSKQRRLLVDFPKGSVSNAQQPDLSKAVSLSMGLYMGETETKVMGNDLGFPQQGQISLSSGETDLKLLEESIANLNRSTSVPENPKSSASTAVSAAPTEKEFPKTHSDVSSEQQHLKGQTGTNGGNVKLYTTDQSTFDILQDLEFSSGSPGKETNESPWRSDLLIDENCLLSPLAGEDDSFLLEGNSNEDCKPLILPDTKPKIKDNGDLVLSSPSNVTLPQVKTEKEDFIELCTPGVIKQEKLGTVYCQASFPGANIIGNKMSAISVHGVSTSGGQMYHYDMNTASLSQQQDQKPIFNVIPPIPVGSENWNRCQGSGDDNLTSLGTLNFPGRTVFSNGYSSPSMRPDVSSPPSSSSTATTGPPPKLCLVCSDEASGCHYGVLTCGSCKVFFKRAVEGQHNYLCAGRNDCIIDKIRRKNCPACRYRKCLQAGMNLEARKTKKKIKGIQQATTGVSQETSENPGNKTIVPATLPQLTPTLVSLLEVIEPEVLYAGYDSSVPDSTWRIMTTLNMLGGRQVIAAVKWAKAIPGFRNLHLDDQMTLLQYSWMFLMAFALGWRSYRQSSANLLCFAPDLIINEQRMTLPCMYDQCKHMLYVSSELHRLQVSYEEYLCMKTLLLLSSVPKDGLKSQELFDEIRMTYIKELGKAIVKREGNSSQNWQRFYQLTKLLDSMHENVMWLKPESTSHTLI